(19) United States
(12) Patent Application Publication
(10) Pub. No.: US 2018/0211477 A1
(43) Pub. Date: Jul. 26, 2018

(54) VIDEO SLOT MACHINE, SERVER SYSTEM, AND COMPUTER SYSTEM

(71) Applicant: BANDAI NAMCO ENTERTAINMENT INC., Tokyo (JP)

(72) Inventor: Kazuki Matsumura, Yokohama-shi (JP)

(73) Assignee: BANDAI NAMCO ENTERTAINMENT INC., Tokyo (JP)

(21) Appl. No.: 15/875,499

(22) Filed: Jan. 19, 2018

(30) Foreign Application Priority Data
Jan. 24, 2017 (JP) 2017-010393

(51) Int. Cl. G07F 17/32

(52) U.S. Cl. CPC G07F 17/3213; G07F 17/3288; G07F 17/3267

(57) ABSTRACT

When a stopped symbol group satisfies a winning combination establishment condition, a video slot machine sets a stopping order of at least one reel having stopped symbols including a symbol required for the winning combination to be the last. When the stopped symbol group is one short of the symbol to satisfy the winning combination establishment condition, the stopping order of a reel involving the missing symbol is set to be the last. Display control is performed in such a manner that the reels that are spinning displayed stop spinning in accordance with the stopping orders thus set.

Japanese Patent Application No. 2017-010393 filed on Jan. 24, 2017 is hereby incorporated by reference in its entirety.

### BACKGROUND

Video slot machines are slot machines with symbol (graphic) columns in spinning reels, in a mechanical slot machine, implemented with video images. The video slot machines have gained popularity with behaviors of reels and payout patterns that would have been unachievable by mechanical slot machines.

For example, Japanese Patent Application Publication No. 2008-36163 discloses a technique of achieving a wide variety of scatter payouts, based on combinations of symbols in reels and background colors of the reels. Japanese Patent Application Publication No. 2015-66396 discloses a technique of implementing the background of a reel with a video reel and using graphic, formed for the second reel, for payout patterns.

Among various aspects that can make the video slot machines distinguishable from other machines and more attractive, a process before a stopped symbol group (the outcome which is a combination of the graphics (symbols) at the timing when the reels have stopped) is determined and variation of the payout patterns are of particularly important. This is because the wait time, before the stopped symbol group is determined, is when the player has increased expectations and feels thrill and excitement.

### SUMMARY

According to one aspect of the invention, there is provided a video slot machine comprising: at least one processor or circuit programmed to execute as:

determining stopped symbols, in symbol column of reels scroll displayed, to be stopped in a reel display area, by performing a predetermined lottery process in response to a predetermined start operation; and

controlling stopping orders of the reels based on the stopped symbols.

According to the second aspect of the invention, there is provided a server system comprising: at least one processor or circuit programmed to execute as:

causing a user terminal to control progress of a video slot game in which symbol columns of reels are scroll displayed in response to a predetermined start operation;

determining stopped symbols, in the symbol columns of the reels, to be stopped in a reel display area, by performing a predetermined lottery process in response to the start operation; and

controlling stopping orders of the reels based on the stopped symbols.

According to the third aspect of the invention, there is provided a computer system including a user terminal on which a user inputs an operation and a server system,

the server system comprising: at least one processor or circuit programmed to execute as:

causing a user terminal to control progress of a video slot game in which symbol columns of reels are scroll displayed in response to a predetermined start operation;

determining stopped symbols, in the symbol columns of the reels, to be stopped in a reel display area, by performing a predetermined lottery process in response to the start operation; and

controlling stopping orders of the reels based on the stopped symbols.

### BRIEF DESCRIPTION OF THE DRAWINGS

FIG. 1 is a front outer view illustrating an example of a configuration of a video slot machine according to a first embodiment.

FIG. 2 is a diagram illustrating an example of a game screen according to the first embodiment.

FIG. 3 is a diagram illustrating relationship between reels and a reel display area.

FIG. 4 is a diagram illustrating an example of a game screen of a bonus game stage.

FIG. 5 is a diagram illustrating an example of a stopped symbol group and an example of reel stopping order setting (part 1).

FIG. 6 is a diagram illustrating an example of a stopped symbol group and an example of the reel stopping order setting (part 2).

FIG. 7 is a diagram illustrating an example of how a game screen transitions (part 1).

FIG. 8 is a diagram illustrating an example of how a game screen transitions (part 2).

FIG. 9 is a diagram illustrating an example of how a game screen transitions (part 3).

FIG. 10 is a diagram illustrating an example of how a game screen transitions (part 4).

FIG. 11 is a diagram illustrating an example of how a game screen transitions (part 5).

FIG. 12 is a block diagram illustrating an example of a configuration of the video slot machine according to the first embodiment.

FIG. 13 is a diagram illustrating an example of a program and data stored in an information storage section of the video slot machine according to the first embodiment.

FIG. 14 is a diagram illustrating an example of a data structure of winning combination defining data (part 1).

FIG. 15 is a diagram illustrating an example of a data structure of winning combination defining data (part 2).

FIG. 16 is a diagram illustrating an example of a data structure of stopped symbol group data.

FIG. 17 is a diagram illustrating an example of a data structure of stopping order determining symbol pick up data (part 1).

FIG. 18 is a diagram illustrating an example of a data structure of stopping order determining symbol pick up data (part 2).

FIG. 19 is a diagram illustrating an example of a data structure of reel stopping order setting data.

FIG. 20 is a flowchart illustrating a flow of a main process performed by a video slot machine.

FIG. 21 is a flowchart illustrating a flow of a last stopping reel determination process.

FIG. 22 is a flowchart continuing from FIG. 21.

FIG. 23 is a flowchart illustrating a flow of a first stopping reel determination process.

FIG. 24 is a diagram illustrating an example of a configuration of a game system according to a second embodiment.

FIG. 25 is a block diagram illustrating an example of a configuration of a server system according to the second embodiment.

FIG. 26 is a diagram illustrating an example of a program and data stored in a server storage section according to the second embodiment.

FIG. 27 is a block diagram illustrating an example of a configuration of a user terminal according to the second embodiment.

FIG. 28 is a block diagram illustrating an example of a configuration of a user terminal according to the third embodiment.

FIG. 29 is a diagram illustrating an example of a program and data stored in a terminal storage section of the user terminal according to the third embodiment.

### DESCRIPTION OF EXEMPLARY EMBODIMENTS

According to one embodiment of the invention, there is provided a video slot machine comprising: at least one processor or circuit programmed to execute as:

determining stopped symbols, in symbol column of reels scroll displayed, to be stopped in a reel display area, by performing a predetermined lottery process in response to a predetermined start operation; and

controlling stopping orders of the reels based on the stopped symbols.

The video slot machine may further comprise determining whether or not a predetermined winning condition is satisfied based on the stopped symbols,

the controlling the stopping orders of the reels may include making, when the winning condition is satisfied, a reel involving a stopped symbol required for satisfying the winning condition to be stopped last.

With this configuration, the stopping orders of the reels can be changed in accordance with the content of the stopped symbol group to be stopped in the reel display area when the reels stop. In a conventional configuration where the stopping orders of the reels are determined in advance, a player might immediately realize that his or her expectation has been disappointed immediately after the reels start stopping, and might have nothing to do but wait until the remaining reels stop. In the present embodiment, the reel stopping orders are changed so that a reel involving a stopped symbol required for satisfying the winning condition is stopped last. Thus, the period in which the player can enjoy the excitement and thrill can be maintained longer than in the conventional configuration, whereby an attractive video slot machine can be implemented.

The video slot machine may further comprise determining whether or not an only one missing condition is satisfied with the winning condition failed to be satisfied due to only one missing symbol based on the stopped symbol, the only missing symbol may be a missing symbol in a case where the winning condition is not satisfied due to only one symbol missing,

the controlling the stopping orders of the reels may include making, when the only one missing condition is satisfied, a reel involving the only missing symbol to be stopped last.

With this configuration, when the winning condition is not satisfied but when the “one missing condition” (“only one symbol missing to satisfy the winning condition”) is satisfied, the reels are also controlled to be stopped as in the case where the winning condition is satisfied. Thus, an attractive video slot machine featuring a longer period of time for the player to enjoy the excitement and thrill regardless of whether or not he or she has won a jackpot can be implemented.

In the video slot machine, a special symbol may be included in the symbol columns of M (N>M≥2) reels of the reels including N (N≥3) reels,

the winning condition may include a condition satisfied when the stopped symbols in the M reels include the special symbol.

With this configuration, the winning condition can be satisfied when the stopped symbols include the special symbol set to be in reels less than all the reels.

In the video slot machine, the controlling the stopping orders of the reels may include making, when the stopped symbols include at least one symbol required for satisfying the winning condition, a reel involving the symbol to be stopped first.

With this configuration, when the stopped symbols include at least one symbol required for satisfying the winning condition, a reel involving the symbol is stopped first. As a result, the player can be quickly excited feeling “Hey, I might have won”.

In the video slot machine, the N may be N≥4,

the controlling the stopping orders of the reels may include determining, when the winning condition is satisfied, reels involving stopped symbols required for satisfying the winning condition to be a first stopped reel and a last stopped reel, and randomly determining reels to be stopped after the first stopped reel and before the last stopped reel.

In the video slot machine, the winning condition may include a plurality of types of winning conditions with different payouts,

the controlling the stopping orders of the reels may include making, when a plurality of the winning conditions are satisfied, a reel involving a stopped symbol required for satisfying one of the winning conditions with largest payout, to be stopped last.

Players feel larger anticipation and excitement for a jackpot with a larger payout. Thus, in the present embodiment, the reel involving the stopped symbol required for satisfying the winning condition with the largest payout is stopped last to further enhance the excitement and thrill of the player.

In the video slot machine, the controlling the stopping orders of the reels may include controlling number of reels to be stopped last at one time.

With this configuration, the number of reels to be stopped last at one time is variable so that a variety of reel stopping patterns can be achieved.

According to another embodiment of the invention, there is provided a server system comprising: at least one processor or circuit programmed to execute as:

causing a user terminal to control progress of a video slot game in which symbol columns of reels are scroll displayed in response to a predetermined start operation;

determining stopped symbols, in the symbol columns of the reels, to be stopped in a reel display area, by performing a predetermined lottery process in response to the start operation; and

controlling stopping orders of the reels based on the stopped symbols.

With this configuration, a server system having the effects described above can be implemented as a server system that enables a video slot game to be played with a user terminal.

According to another embodiment of the invention, there is provided a computer system including a user terminal on which a user inputs an operation and a server system,

the server system comprising: at least one processor or circuit programmed to execute as:

causing a user terminal to control progress of a video slot game in which symbol columns of reels are scroll displayed in response to a predetermined start operation;

determining stopped symbols, in the symbol columns of the reels, to be stopped in a reel display area, by performing a predetermined lottery process in response to the start operation; and

controlling stopping orders of the reels based on the stopped symbols.

The “computer system” as used herein may be a system including a single computer, and may be a system including a plurality of computers that are connected to each other to be capable of performing data communications with each other through a communication line.

According to this configuration, a computer system that can achieve the effects described above can be implemented.

Exemplary embodiments of the present invention are described below. It is a matter of course that modes to which the present invention can be applied are not limited to the embodiments described below.

### First Embodiment

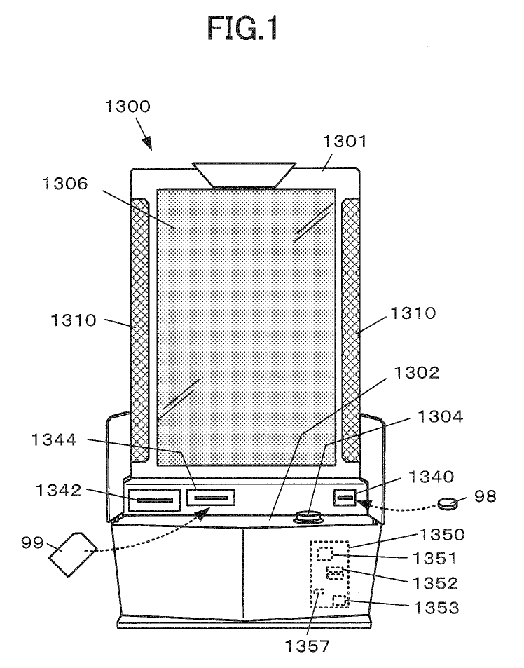

FIG. 1 is a front outer view illustrating an example of a configuration of a video slot machine 1300 according to the present embodiment. The video slot machine 1300 includes a casing 1301 having a lower portion provided with an operation board 1302 having an upper surface provided with a spin button 1304.

The video slot machine 1300 further includes a token input device 1340, a paper money input device 1342, and a medium reading device 1344. The token input device 1340, serving as a playing fee input section, is provided to be farther than the operation board 1302, and is used for inputting a token 98. The medium reading device 1344 reads information, required for paying the playing fee, from an electronic payment medium 99.

For example, the electronic payment medium 99 may be implemented with an admission ticket issued by a manager of the video slot machine 1300, credit card, prepaid card, integrated circuit (IC) card, smartphone, a wearable computer, or the like. In the example illustrated in FIG. 1, the electronic payment medium 99 is illustrated to be a card type and the medium reading device 1344 is illustrated to have a card insert port. Note that the electronic payment medium 99 and the medium reading device 1344 may establish connection via near field communications so that the medium reading device 1344 can write and read information to and from the electronic payment medium 99.

The video slot machine 1300 further includes a touch panel 1306 and a speaker 1310 in an upper portion of the casing 1301. The touch panel 1306 functions as an image display device and a contact position input device. The casing 1301 incorporates a control board 1350.

The control board 1350 is a board dedicated for the video slot machine 1300. The control board 1350 includes a microprocessor of various types (such as a central processing unit (CPU) 1351, a graphics processing unit (GPU), and a digital signal processor (DSP)), an IC memory 1352 of various types (such as a video random access memory (VRAM), a RAM, and a read only memory (ROM)), an interface (I/F) controller 1357, and the like.

For example, the I/F controller 1357 includes 1) a driver circuit for the touch panel 1306, 2) a circuit that receives a signal from the spin button 1304, 3) an output amplifier circuit that outputs a sound signal to the speaker 1310, 4) a signal input/output circuit for playing fee input sections such as the token input device 1340, the paper money input device 1342, and the medium reading device 1344, and the like.

These elements of the control board 1350 are electrically connected to each other via a bus circuit, to be capable of exchanging data and signals. The control board 1350 may be partially or entirely implemented with an Application Specific Integrated Circuit (ASIC), a field-programmable gate array (FPGA), or a System on a Chip (SoC).

The control board 1350 executes a predetermined program to perform a calculation process, and enables slot play by controlling the components of the video slot machine 1300 in accordance with an operation input using the spin button 1304 and the touch panel 1306. The video slot machine 1300 has a required program and various types of setting data stored in advance in the IC memory 1352. Note that the program and data can be downloaded from an external device every time the machine is started. In such a configuration, the video slot machine 1300 may include a communication device 1353.

The control board 1350 performs control so that the video slot machine 1300 generates an image on a game screen of a slot game based on a result of the operation input using the spin button 1304, the touch panel 1306, or the like, causes the touch panel 1306 to display the image, generates a sound signal corresponding to sound effects and operation sounds, and causes the speaker 1310 to emit the sound. Thus, the player can enjoy the slot game by operating the spin button 1304 while watching the game screen displayed on the touch panel 1306 and listening to the game sound from the speaker 1310.

One or two of the token input device 1340, the paper money input device 1342, and the medium reading device 1344 may be omitted. Furthermore, a playing fee input section other than these may be employed. The video slot machine 1300 includes a power source device (not illustrated) and the like as appropriate.

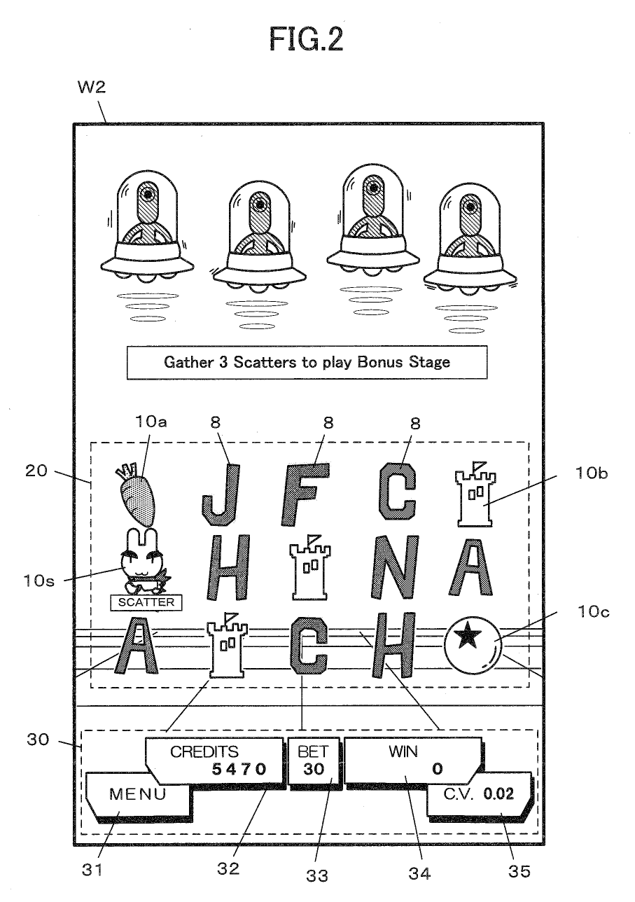

FIG. 2 is a diagram illustrating an example of a game screen according to the present embodiment. A game screen W2 according to the present embodiment is displayed on the touch panel 1306. The game screen W2 according to the present embodiment includes a reel display area 20 and an information display section 30.

The reel display area 20 includes two or more symbol stop positions for each of N reels (N≥3). In the present embodiment, N=5. In the reel display area 20, symbol columns of the reels are displayed in a scrolling manner so that an image displayed replicates actual spinning reels.

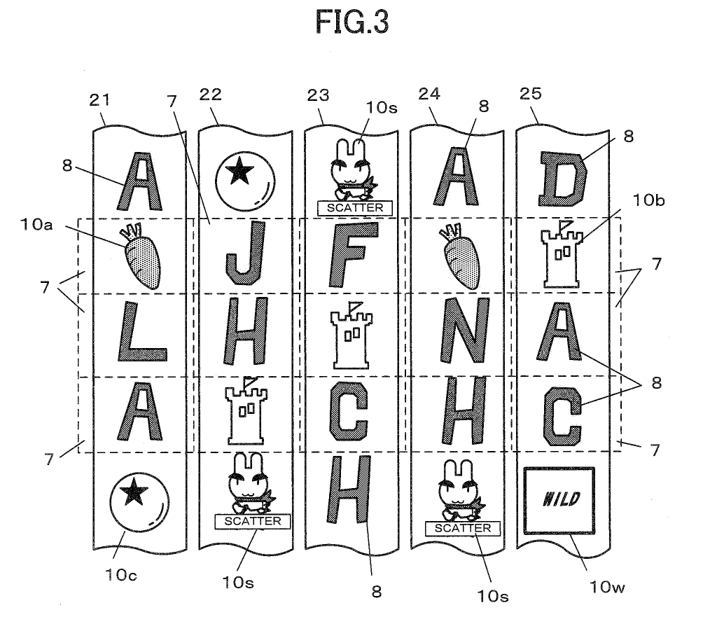

In the present embodiment, a design illustrated in FIG. 3 is employed where five video reels (first video reel 21 to fifth video reel 25) are arranged in a left and right direction. Three of continuous symbols (general symbols 8 and special symbols 10 (10s, 10a, 10b, . . . )) in a column of symbols (symbol column), set to each video reel, are designed to be displayed on the reel display area 20. Thus, in the present embodiment, a total of 15 (5×3) symbol stop positions 7 (areas sectionalized with broken lines in FIG. 3) are prepared.

Symbols to be stopped in the reel display area 20, that is, symbols to be stopped at the symbol stop positions 7 are hereinafter referred to as “stopped symbols”.

Edges of the reels, clearly illustrated in FIG. 3, are not actually displayed in the reel display area 20 as illustrated in FIG. 2. The number of symbols, in the symbol column of each reel, to be displayed on the reel display area 20 can be appropriately set. In other words, the number of symbol stop positions 7 can be appropriately set. For example, the number of the symbol stop positions 7 may be three in each of the first reel 21 and the second reel 22 and may be four in each of the third reel 23 to the fifth reel 25. The number of the symbol stop positions 7 may be variable.

Symbols set in the video reels (first reel 21 to fifth reel 25) according to the present embodiment include a plurality of types of special symbols 10 (10s, 10a, 10b, . . . ) that are less than the general symbols 8 (alphabet symbols in the illustrated example).

A reward is given to the player when the “content of the stopped symbol group”, that is, the “reel outcome” includes a predetermined number of or a predetermined arrangement of the special symbols 10 (10s, 10a, 10b, . . . ) stopped at the symbol stop positions 7 to satisfy a given winning combination establishment condition. The video slot machine 1300 determines the stopped symbol group through a predetermined lottery process, and thus the winning combination establishment condition can also be referred to as a “winning condition”.

The “winning combination” is a combination of the stopped symbol group required for the payout after the reels have stopped.

The winning combination establishment condition is a condition satisfied when a combination of the stopped symbol group is determined to match a winning combination, and can be appropriately set. In the present embodiment, two types of the condition are prepared. More specifically, an individual payout line determination type and an entire symbol stop positions collective determination type are prepared.

The “payout line” is an array of the symbol stop positions 7 that is a target of the betting, that is, an array of a plurality of the symbol stop positions 7 picked up from the symbol stop positions 7 set to be arranged in a matrix form based on a predetermined direction or a geometric pattern. In the present embodiment, the payout lines are set to be three linear arrays of the symbol stop positions 7 in the left and right direction and on upper, middle, and lower rows, for the sake of description. However, how the payout lines are set is not limited to this, and the lines can be appropriately set.

The winning combination establishment condition of the individual payout line determination type is defined based on the types and the consecutive number of symbols, stopped at the symbol stop positions 7, sequentially picked up along each payout line at which the bet is set (set as the betting target). The “consecutive number” is the number of the same type of stopped symbols arranged over a plurality of continuously adjacent reels, with no symbol of a different type provided in between.

The winning combination establishment condition of the individual payout line determination type is a condition of determining whether or not the winning combination is established for each payout line, and the type and the consecutive number of symbols may be appropriately set. For example, the condition may be set to be satisfied with a mixture of different types of symbols, with the consecutive number intentionally set to be “1”, or with a certain symbol stopped at a certain reel (for example, the third reel 23). A large symbol that occupies two or more symbol stop positions in an upper and lower direction may be employed, and the condition may be satisfied when such a large symbol stops.

The winning combination establishment condition of the entire symbol stop positions collective determination type is defined based on the type and the appeared number of special symbols in all of the symbols that have stopped at all the symbol stop positions 7.

The special symbols 10 (10s, 10a, 10b, . . . ) according to the present embodiment include a scatter symbol 10s, a wild symbol 10w, a first small jackpot symbol 10a, a second small jackpot symbol 10b, and a third small jackpot symbol 10c. Note that the types of the special symbols are not limited to these.

The scatter symbol 10s is a symbol that may lead to a special event occurring as a reward, and is associated with the winning combination establishment condition of the entire symbol stop positions collective determination type. In the present embodiment, the second reel 22, the third reel 23, and the fourth reel 24 are each set as a “special reel” and have a symbol column including at least one scatter symbol 10s. The illustrated combination is determined to be a jackpot under the winning combination establishment condition set to be satisfied when the appeared number is “3” and the number of scatter symbols 10s in the stopped symbols at all the symbol stop positions 7 is “3” or more.

Note that how the special reels are set is not limited to this. The special symbol may be included in the symbol column of each of M (N>M≥2) reels of N (N≥3) reels. In the example of the present embodiment, the scatter symbol 10s serving as the special symbol is included in each of the second to the fourth reels 22, 23, and 24 (N=5 and M=3). However, this should not be construed in a limiting sense. For example, three reels including the first reel 21, the third reel 23, and the fifth reel 25 may be set to be the “special reels”. Furthermore, all the five reels may be set to be the special reels (N=M). In such a case, the appeared number in the winning combination establishment condition is preferably set to be “3 or more” or “5”.

In the present embodiment, it is determined that “a large jackpot is established” or “the player has won the large jackpot” when the number of the scatter symbols 10s that have stopped at the symbol stop positions 7 is equal to or larger than the appeared number in the winning combination establishment condition. As a result, a bonus game stage starts as a reward.

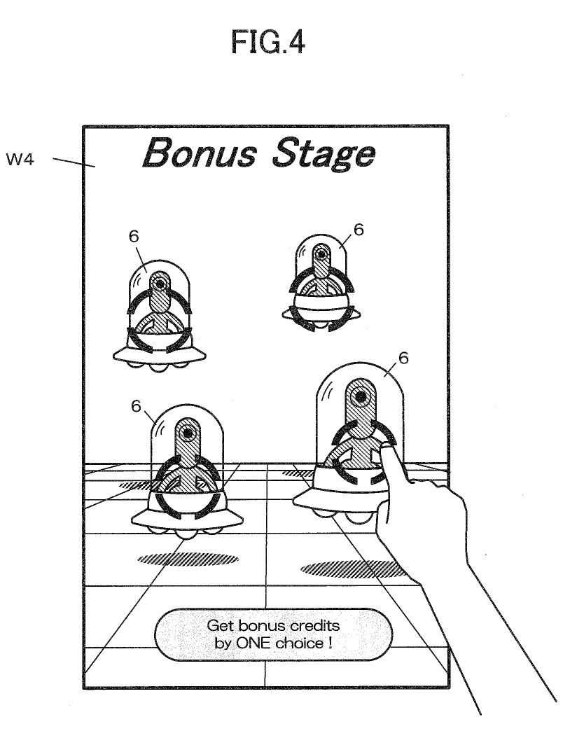

The bonus game stage according to the present embodiment is a game in which the player touches and selects one of a predetermined number of the characters 6 displayed over the entire screen of a touch panel 1506, as illustrated in an example of a game screen W4 in FIG. 4 for example, and an action operation is performed on the character 6 thus selected. The characters 6 are assigned with different bonus credit in advance. The bonus credit is set to be more expensive than the payout for any jackpot.

When the player performs the selection operation, display effect of shooting down the character 6 thus selected occurs, and the bonus credit assigned to the character 6 is given to the player. Then, the bonus game ends, and the display returns to the game screen of the slot game (see FIG. 2).

Referring back to FIG. 3, the wild symbol 10w, the first small jackpot symbol 10a, the second small jackpot symbol 10b, and the third small jackpot symbol 10c are included in the symbol columns of all of the first reel 21 to the fifth reel 25. The number of each of these symbols is larger than that of the scatter symbol 10s, but is set to be much smaller than that of the general symbols 8.

The first small jackpot symbol 10a, the second small jackpot symbol 10b, and the third small jackpot symbol 10c are each associated with the winning combination establishment condition of the individual payout line determination type. Thus, it is determined that “a small jackpot is established” when the types and the consecutive number of symbols picked up along the payout line set to be the betting target, from the group of symbols that have stopped at the symbol stop positions 7 (stopped symbol group), satisfy the winning combination establishment condition. The small jackpot involves no bonus event occurring in the case where the scatter symbol 10s is involved, but involves a relatively high payout ratio as a reward.

The player receives the payout in the video slot machine 1300 in various situations. In any situations, the player is definitely interested in where the special symbols 10 (10s, 10a, 10b, . . . ) stop in the reel display area 20. The player is extremely interested in how many scatter symbols 10s appear.

Thus, the scatter symbol 10s is picked up as a representative special symbol to facilitate the understanding of the present embodiment. Specifically, how the player feels while patiently waiting for three scatter symbols 10s to stop in the reel display area 20, that is, while waiting for a large jackpot is considered.

In a conventional video slot machine where a plurality of reels stop one by one from the left as viewed from the player, the player notices that there will be no bonus game stage even when the third reel 23 to the fifth reel 25 are spinning, as soon as he or she finds out that the symbols in the second reel 22 that have stopped in the reel display area 20 include no scatter symbol 10s.

Thus, the player has to meaninglessly wait until the third reel 23 to the fifth reel 25 stop, only to be less involved in the game. A chance of winning a large jackpot is generally very low. Thus, in this spin, the player patiently waiting for a large jackpot is excited playing the video slot machine only until the second reel 22 stops after a spin operation has been performed, meaning that he or she loses interest in most of the time. This only makes the video slot machine less attractive.

In view of this, in the video slot machine 1300 according to the present embodiment, the stopping order of the reels is not limited to a single stopping pattern. The stopping order of the reels is changed in accordance with the contents of the symbols scheduled to be stopped in the reel display area 20, that is, the stopped symbol group. Thus, a period less interesting to the player is set to be short as much as possible, and a period exciting to the player is set to be long as much as possible, whereby the game more attractive than the conventional case is achieved.

Specifically, one or a plurality of reels at least including the last symbol required for the player to determine the content of the stopped symbol group, is set to be the “last” in the stopping order, depending on the content of the stopped symbol group to be determined. This is referred to as “last stopping reel setting”.

Specifically, when the winning combination has been established with the stopped symbol group, at least one of reels that stop with the special symbols 10 (hereinafter, referred to as “jackpot forming symbols”) forming the winning combination is set to be “stopping order=last”. When none of winning combination is established, but the player is only one jackpot forming symbol short, that is, when the player is only “one short” from winning the jackpot, at least one of reels with the symbol column that includes the jackpot forming symbol but does not stop with the jackpot forming symbol in the display area is set to be “stopping order=last”.

In other words, it is determined whether or not only one missing condition is satisfied with one of symbols required for satisfying a winning condition missing, based on the stopped symbol group. When the only one missing condition is satisfied, a reel involving the only one missing symbol (missing one of symbols required for satisfying the winning condition) is set to be the last reel to be stopped.

When none of the winning combinations is satisfied, the reel set to be “stopping order=last” is randomly determined.

With the last stopping reel thus set, excitement and thrill can be maintained due to the stopped symbol group being not determinable until all of the reels stop, whereby a more attractive video slot game can be achieved.

When the content of the stopped symbol group establishes a winning combination based on the special symbol 10 (the scatter symbol 10s in particular) or is one short from establishing the winning combination, the stopping order of at least one of reels that stop with the jackpot forming symbol as a part of the winning combination included in the display area is set to be the “first”. This is referred to as “first stopping reel setting”. With this first stopping reel setting, the player can feel “Hey, I might have won the winning combination” as soon as the reels start stopping, and thus can feel anticipation for winning the winning combination. The last stopping reel setting further works to enhance excitement and thrill. The first stopping reel may be set based on a given probability so that the player is prevented from knowing that the winning combination is not established or that he or she is not even one short from winning the winning combination, due to the special symbol 10 not appearing when the first stopping reel stops.

In the “first stopping reel setting”, the stopping order of the reel, involving the jackpot forming symbol, arranged closest to the center of the reel may be set to be the “first”. Thus, the reel involving the special symbol is to be stopped immediately as described above, and with the stopping order of the reel closer to the center of the screen set to be the “first” with a higher priority, a higher visual impact can be achieved to make the player feel higher anticipation for winning a large jackpot.

The last stopping reel setting and the first stopping reel setting are described more in detail based on an example of the stopped symbol group.

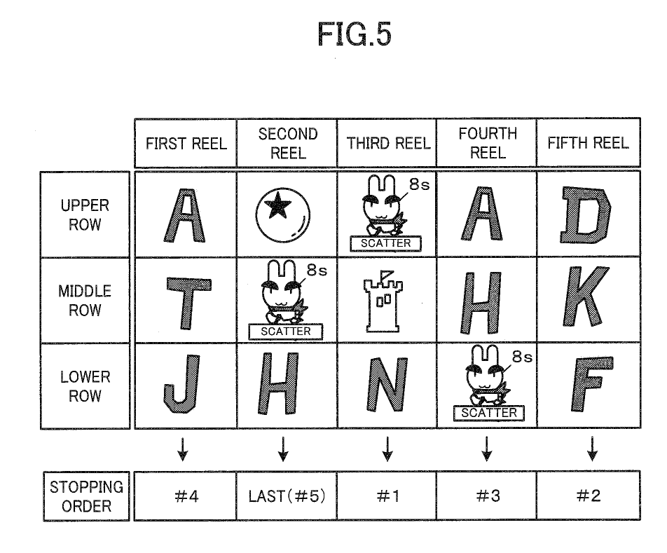

FIG. 5 is a diagram illustrating an example of the stopped symbol group and an example of the reel stopping order setting according to the present embodiment. In the illustrated case, the player has won a “large jackpot” with the three scatter symbols 10s all stopped at the symbol stop positions 7.

First of all, the video slot machine 1300 determines the stopped symbol group and checks the established winning combination. It is a matter of course that the stopped symbol group is determined and the winning combination is checked before the reels stop. One of jackpots, won with established winning combinations, involving the highest payout ratio is set to be a reference for setting the reel stopping order (“stopping order setting reference winning combination”). In the example illustrated in FIG. 5, the stopping order setting reference winning combination is a “large jackpot”.

The stopped symbol group illustrated in FIG. 5 is displayed after all the reels stop. In the example illustrated in FIG. 5, the scatter symbol 10s that is a symbol (jackpot forming symbol) forming the large jackpot is a symbol required for the player to recognize that the winning combination is established. A reel that involves one or a plurality of scatter symbols 10s and is arranged on a relatively outer side, in the scatter symbols 10s of the stopped symbol group, is set to be “stopping order=last (#5)”. FIG. 5 illustrates an example where the second reel 22 is set to be “stopping order=last (#5)”.

Next, a reel that is not the reel set to be “stopping order=last” and is one of the reels stopped with the jackpot forming symbol of the stopping order setting reference winning combination (the scatter symbol 10s in this example) arranged closest to the center is set to be “stopping order=#1”. In the example illustrated in FIG. 5, the third reel 23 is set to be “stopping order=#1”.

Then, the stopping orders of the remaining reels other than the reels set to be “stopping order=#1” and “stopping order=last (#5)” are randomly set.

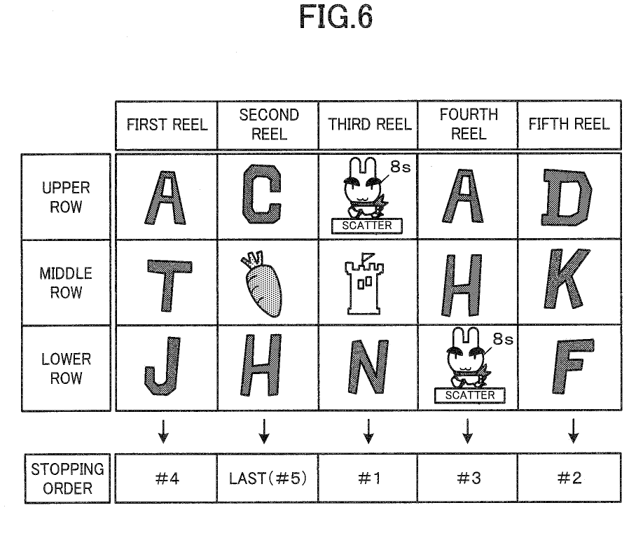

Another example is described. FIG. 6 is a diagram illustrating an example of a stopped symbol group and an example of the reel stopping order setting according to the present embodiment in a case where the player is one scatter symbol 10s short from winning a large jackpot.

The video slot machine 1300 determines that the player has failed to win a jackpot due to lacking of the one jackpot forming symbol. Thus, this is a case where the player has failed to win the winning combination due to the lack of a single jackpot forming symbol. The video slot machine 1300 sets a reel with the symbol column including the jackpot forming symbol as a part of the winning combination failed to be established and does not stop without the jackpot forming symbol displayed to be “stopping order=last (#5)” In the example illustrated in FIG. 6, the second reel 22 is set to be the last reel to be stopped.

In the first stopping reel setting, the reel involving the special symbol that is not the reel set to be “stopping order=last” and is arranged closest to the center is set to be “stopping order=#1”. FIG. 6 illustrates an example where the third reel 23 is set to be “stopping order=#1”.

Then, the stopping orders of the remaining reels other than the reels set to be “stopping order=#1” and “stopping order=last (#5)” are randomly set.

Next, an effect of the reel stopping order setting is described.

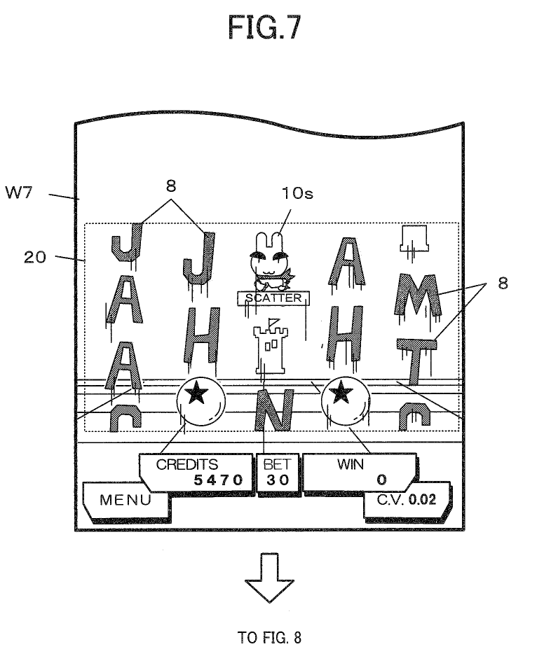

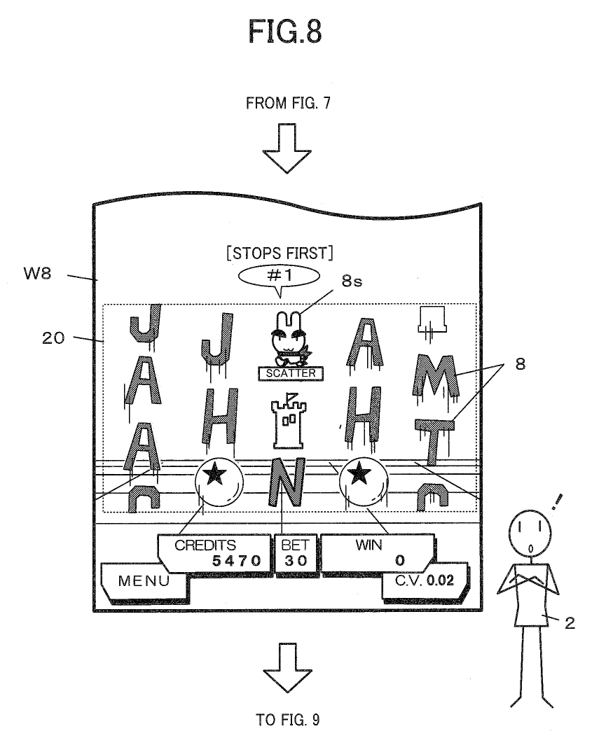

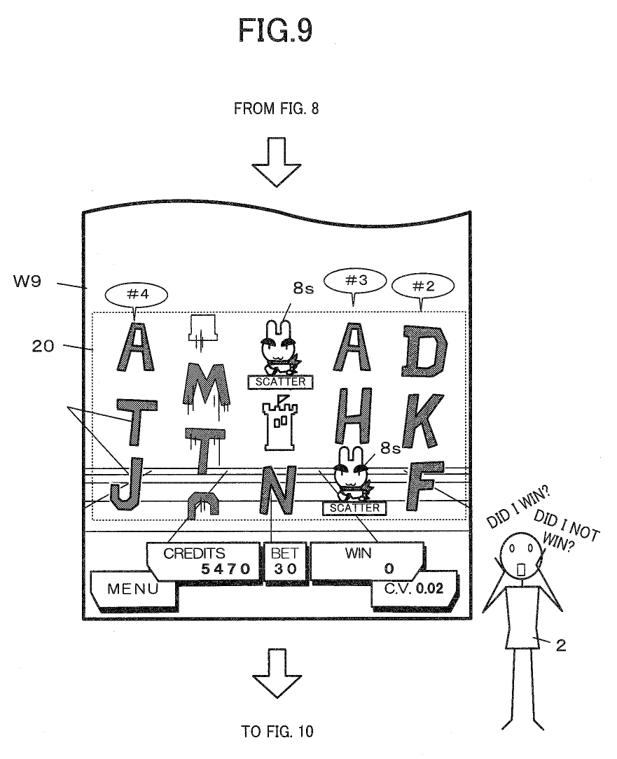

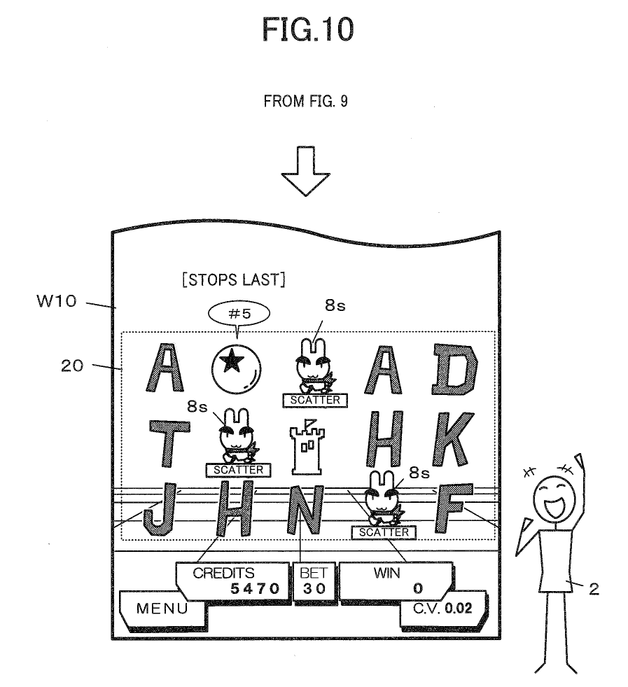

FIG. 7 to FIG. 11 illustrate an example of how a video slot screen transitions. A sequence in the order of FIG. 7→FIG. 8→FIG. 9→FIG. 10 represents an example of how the screen transitions based on a result of the reel stopping order setting described above with reference to FIG. 5. A popup in the figures is a comment for the description, and is not actually displayed on the video slot screen.

First of all, when a spin operation is input as in an example game screen W7 in FIG. 7, the video slot machine 1300 determines the stopped symbol group and then starts rotation control for the reels, or starts the rotation control for the reels and then determines the stopped symbol group. In any cases, the stopped symbol group is determined before the reels are stopped. Then, the third reel 23 set to be “stopping order=#1” stops spinning as in an example game screen W8 illustrated in FIG. 8. The stopped symbol of this reel includes the scatter symbol 10s and thus, a player 2 immediately gets excited feeling “Hey, I might win a large jackpot!?”. The special symbol (scatter symbol 10s) first appears at a portion around the center of the reel display area 20 in the left and right direction. This is more impressive than in cases where the special symbol appears first in a reel at one end.

Then, the reels stop in the order of “stopping order=#2”→“stopping order #3”→“stopping order=#4” as in an example game screen W9 illustrated in FIG. 9. Thus, the player 2 keeps being excited feeling “Will I win the large jackpot? Will I not?”. The stopped symbols in the fourth reel 24 set to be “stopping order #3” include the scatter symbol 10s to fuel the excitement.

Finally, the second reel 22 stops spinning as in an example game screen W10 illustrated in FIG. 10. The player 2 can realize that he or she has won the large jackpot with the current stopped symbol group only after the reels have thus stopped. Thus, the player can feel excitement and thrill from the start to the end of the reel spin. The longer the excitement, the larger the joy of winning the winning combination.

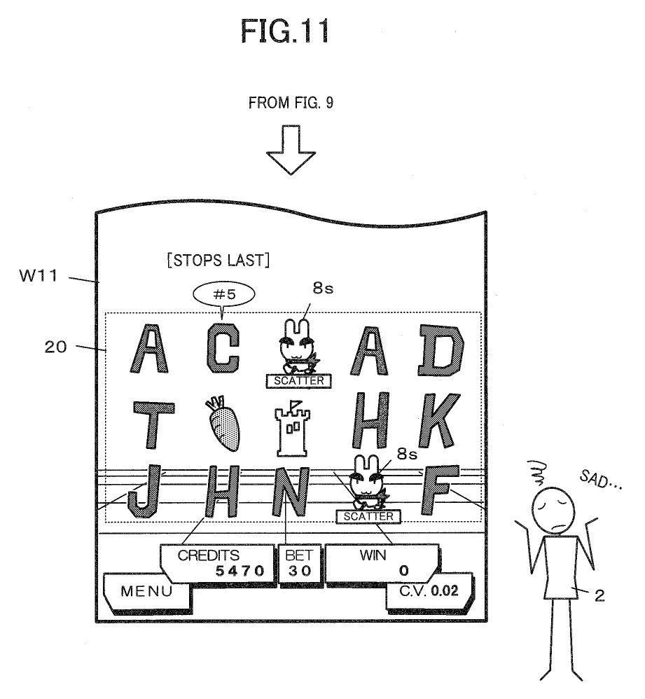

A sequence in the order of FIG. 7→FIG. 8→FIG. 9→FIG. 11 represents an example of screen transition based on a result of the reel stopping order setting described with reference to FIG. 6.

Transition up to the middle of a sequence FIG. 7→FIG. 8→FIG. 9 is the same as the example of the transition based on the result of the reel stopping order setting described above with reference to FIG. 5. However, in this transition example, the player 2 realizes that he or she did not win the largely expected large jackpot only after the last reel has stopped as in an example game screen W11 illustrated in FIG. 11. Also in this case, the player 2 cannot realize whether or not he or she has won the winning combination until the first to the last reels stop, whereby the excitement is maintained for a longer period of time than in conventional cases.

Now, how the stopped symbol group illustrated in FIG. 5 is obtained with a conventional slot machine is explained. The conventional slot machine has a fixed reel stopping pattern in which the reels sequentially stop from the reel at the left end. Thus, the player 2 can start to feel that he or she will win the large jackpot when the second reel 22 stops. Then, the player 2 realizes that he or she has won the large jackpot when the fourth reel 24 stops. Thus, the player 2 feels excitement only in a period corresponding to three reels, that is, a period in which the second to the fourth reels 22, 23, and 24 stop. When the stopped symbol group illustrated in FIG. 6 is obtained with a conventional slot machine, the player 2 realizes that he or she did not win the large jackpot when the second reel 22 stops. Thus, the player 2 realizes the result of single spinning without having enough time to feel excitement, and a period in which the third to the fifth reels stop is nothing more than waiting time. The video slot machine 1300 according to the present embodiment can implement novel display control until the stopped symbol group is determined, whereby much higher interest can be achieved compared with conventional cases.

[Configuration]

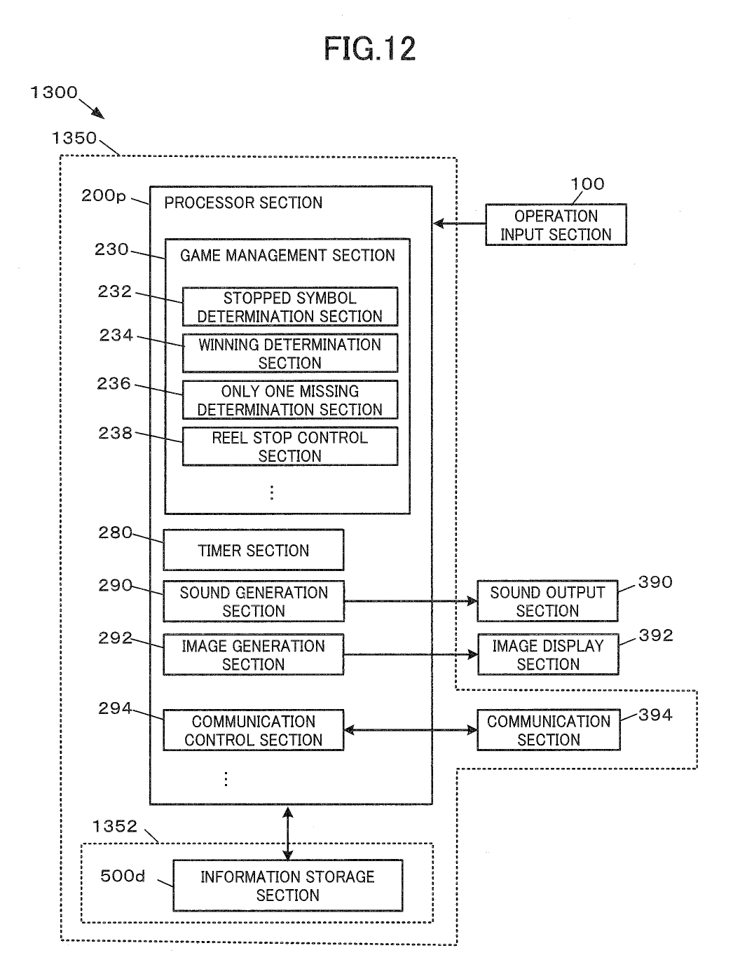

FIG. 12 is a block diagram illustrating an example of a configuration of the video slot machine 1300 according to the present embodiment. The video slot machine 1300 according to the present embodiment includes an operation input section 100, a processor section 200p, a sound output section 390, an image display section 392, and an information storage section 500d. When the video slot machine 1300 needs to communicate with an external device, the control board 1350 further includes a communication unit 394 as appropriate.

The operation input section 100 is for inputting various operations by the player. This corresponds to the spin button 1304 and the touch panel 1306 in FIG. 1.

The processor section 200p is implemented with electronic parts such as a microprocessor (e.g., CPU and GPU), an ASIC, and an IC memory. The processor 200p performs input/output control to exchange data with each of the functional sections including the operation input section 100 and the information storage section 500d. The processor section 200p executes various calculation processes based on a predetermined program or data, an operation input signal from the operation input section 100 to entirely control the operation of the video slot machine 1300.

The processor section 200p according to the present embodiment includes a game management section 230, a timer section 280, a sound generation section 290, and an image generation section 292. Note that other functional sections other than these may be included as appropriate. When the video slot machine 1300 needs to communicate with an external device, a communication control section 294 may further be provided.

The game management section 230 performs various processes related to execution and management of the video slot game in which a symbol column of each of N reels (N≥3) is displayed in a scrolling manner in the reel display area 20 having two symbol stop positions or more. Specifically, the game management section 230 according to the present embodiment includes a stopped symbol determination section 232, a winning determination section 234, an only one missing determination section 236, and a reel stop control section 238.

The stopped symbol determination section 232 performs a predetermined lottery process in response to a predetermined start operation, to determine symbols to be stopped in a reel display area in symbol columns of reel scroll displayed, that is, to determine a group of stopped symbols stopped at all of the symbol stop positions 7.

The winning determination section 234 determines whether or not the predetermined winning condition is satisfied based on the stopped symbols. A plurality of types of winning conditions with different payouts are prepared and are satisfied when the stopped symbols in the M (the number of reels=N≥3 and N>M≥2) reels include the special symbols. Thus, the winning condition corresponds to the winning combination establishment condition according to the present embodiment. Thus, the winning determination section 234 can determine whether or not a winning combination has been established according to the present embodiment.

The only one missing determination section 236 determines whether or not only one missing condition is satisfied based on the stopped symbols. The only one missing condition is satisfied when the player 2 is one short of the symbols, required for satisfying the winning condition, from satisfying the winning condition.

The reel stop control section 238 variably controls the stopping order of the reels based on the stopped symbols. Specifically, the reel stop control section 238 can determine the last stopping reel, the first stopping reel, and intermediate stopping reels.

The reel stop control section 238 determines the last stopping reel through the following processes.

1) When the winning determination section 234 has determined that the winning condition is satisfied, the stopping order is determined in such a manner that the reel involving the stopped symbol required for satisfying the winning condition thus determined to be satisfied is stopped last.

2) When the only one missing condition is satisfied, the stopping order is determined in such a manner that the reel involving the only one missing symbol (one symbol missing so that the winning condition is failed to be satisfied) is stopped last.

3) When a plurality of winning conditions are satisfied, the stopping order is determined in such a manner that the reel involving the stopped symbol required for satisfying the winning condition with the largest payout is stopped last.

4) When a winning condition is satisfied, outermost one of the reels, each involving the stopped symbol required for satisfying the winning condition, is determined to be the reel to be stopped last.

5) The number of reels to be stopped last at one time is variably controlled.

The first stopping reel is determined as follows. Specifically, when the stopped symbols includes at least one symbol required for satisfying a winning condition, the reel stop control section 238 determines the stopping order in such a manner that the reel involving the symbols is stopped first.

The intermediate stopping reels are determined as follows. Specifically, when the winning condition is satisfied, the reel stop control section 238 randomly determines reels to be stopped after the first stopped reel and before the last stopped reel from four or more reels not including the reel, involving the stopped symbol required for satisfying the winning condition, determined to be the first stopped reel and the reel to be stopped last.

The timer section 280 uses a system clock to obtain the current date and time, a time limit, and the like.

The sound generation section 290 is implemented with an integrated circuit (IC) or by executing software that generates sound data and performs decoding, and generates or decodes sound data on a sound related to the video slot, background music (BGM), and a character voice.

The sound output section 390 outputs sound based on the input sound signal. The sound output section 390 corresponds to the speaker 1310 in FIG. 1.

The image generation section 292 can generate a game screen and the like. The image signal for displaying the game screen can be output to the image display section 392.

The image display section 392 displays the game screen based on the image signals input from the image generation section 292. The image display section 392 may be implemented with an image display device such as a flat panel display, a cathode ray tube (CRT), a projector, or a head-mounted display. The image display section 392 corresponds to the touch panel 1306 in the example illustrated in FIG. 1.

The communication control section 294 performs a data communication process for data communications, and exchanges data with an external device through the communication section 394.

The communication section 394 connects to a communication line to implement communications. The communication section 394 is implemented with a transceiver, a modem, a terminal adapter (TA), a jack for a communication cable, a control circuit, and the like.

The information storage section 500d stores a program and various types of data for implementing various functions of the processor section 200p for controlling the video slot machine 1300. The information storage section 500d is used as a work area for the processor section 200p, and temporarily stores the results of calculations performed by the processor section 200p based on various programs. The function of the information storage section 500d is implemented with an IC memory (e.g., RAM and ROM), a magnetic disk (e.g., hard disk), an optical disk (e.g., CD-ROM and DVD), an online storage, or the like corresponding to the IC memory 1352 in the control board 1350 in the example illustrated in FIG. 1. When the video slot machine 1300 can communicate with an external device, the function may be implemented with an external storage prepared on a network.

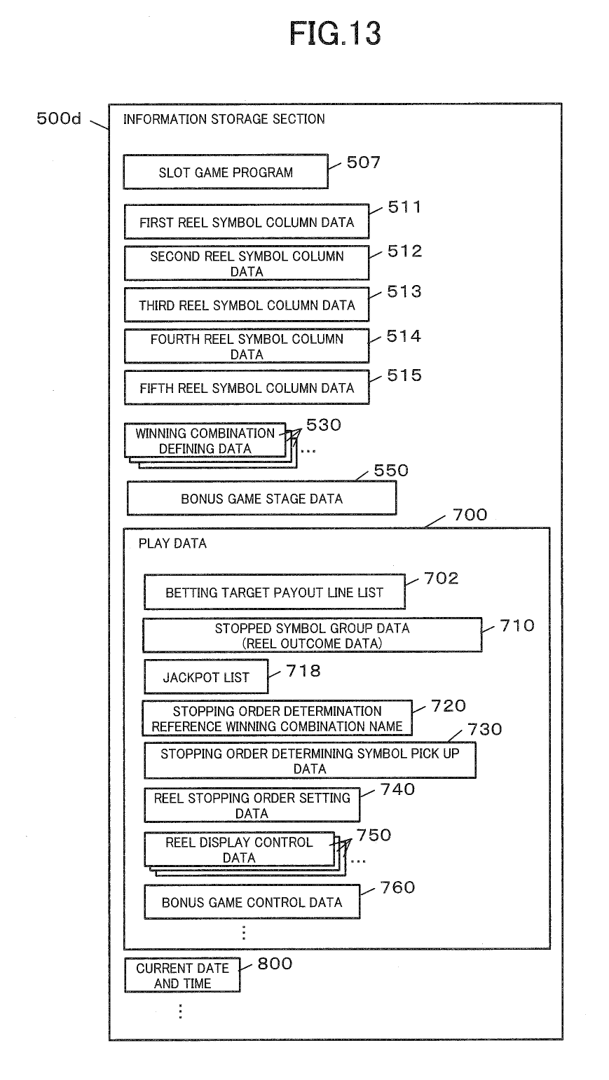

FIG. 13 is a diagram illustrating an example of a program and data stored in the information storage section 500d according to the present embodiment. The information storage section 500d stores a slot game program 507, first reel symbol column data 511, second reel symbol column data 512, third reel symbol column data 513, fourth reel symbol column data 514, fifth reel symbol column data 515, winning combination defining data 530, and bonus game stage data 550 in advance.

The information storage section 500d stores therein data, sequentially generated and managed, including play data 700 and current date and time 800. The information storage section 500d may further store therein various types of information such as a timer, a counter, and various flags.

The slot game program 507 is a program read and executed by the processor section 200p for implementing functions of the game management section 230. The program may include programs for implementing the functions of the sound generation section 290, the image generation section 292, and the communication control section 294.

The first reel symbol column data 511 to the fifth reel symbol column data 515 respectively define the symbol column for the first reel 21 to the fifth reel 25 (see FIG. 3).

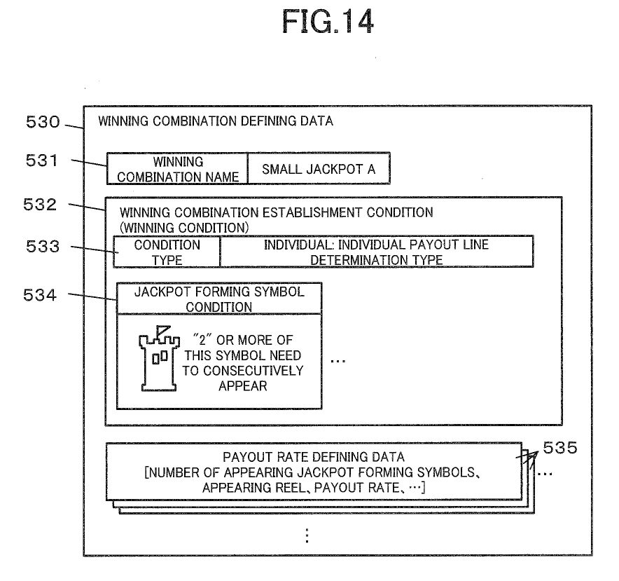

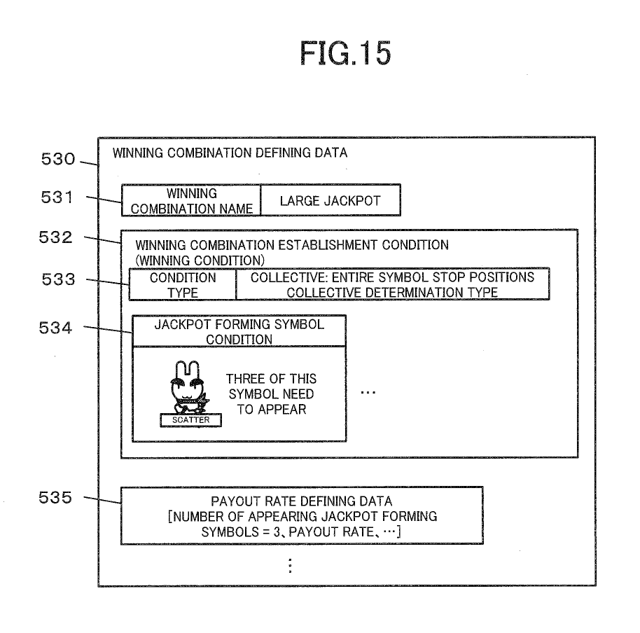

The winning combination defining data 530 is prepared for each winning combination and includes various types of data related to the winning combination. FIG. 14 is a diagram illustrating an example of a data structure of one winning combination defining data 530, and illustrates an example where the winning combination establishment condition of the individual payout line determination type is set. FIG. 15 illustrates an example where the winning combination establishment condition of the entire symbol stop positions collective determination type is set.

As illustrated in FIG. 14 and FIG. 15, one winning combination defining data 530 includes a winning combination name 531, a winning combination establishment condition 532, and payout rate defining data 535. Note that other data can be included as appropriate.

The winning combination establishment condition 532 includes a condition type 533 and a jackpot forming symbol condition 534. Note that other data can be included as appropriate.

The condition type 533 indicates the type of the winning combination establishment condition 532 of the winning combination. In other words, the condition type 533 indicates which symbols in the symbols stopped at the symbol stop position 7 are to be used for determining whether or not the winning combination has been established. In the present embodiment, one of two types, including “individual: individual payout line determination type” and “collective: entire symbol stop positions collective determination type”, is set. When the former is set, the symbols are selected (picked up) for each payout line set to be the betting target from all of the symbols in the stopped symbol group for determining whether or not the winning combination is established. When the latter is set, all the symbols in the stopped symbol group are selected (picked up) for determining whether or not the winning combination is established.

The jackpot forming symbol condition 534 defines a combination of symbols defining the winning combination. For example, for a condition for determining that the player 2 has won a jackpot when the consecutive number of the same type of symbols for satisfying the condition appear regardless of the reel in which the symbols appear, the jackpot forming symbol condition 534 may be described with a single symbol type and the number of symbols for satisfying the condition. A mixture of different types of symbols may be employed. In such a case, a more difficult condition with the appearance order on the payout line is further limited. For such a condition, the order of the symbol, forming the jackpot, in a row or the left and right direction may be defined.

The payout rate defining data 535 defines the payout rate applied when the winning combination is determined to have established. When the payout rate is changed depending on the stopped symbol group, a plurality of pieces of the payout rate defining data 535 may be prepared. In the present embodiment, the largest payout rate is set for a “large jackpot” obtained when three scatter symbols 10s appear.

Referring back to FIG. 13, the bonus game stage data 550 includes various types of data for implementing the bonus game stage (see FIG. 4).

The play data 700 includes various types of data describing a progress status of the video slot game.

In the present embodiment, the data includes a betting target payout line list 702, stopped symbol group data 710, a jackpot list 718, a stopping order determination reference winning combination name 720, stopping order determining symbol pick up data 730, reel stopping order setting data 740, reel display control data 750, and bonus game control data 760. Note that other data can be included as appropriate. For example, the data may further include a parameter value displayed on display sections of the information display section 30 (see FIG. 2) as appropriate.

The betting target payout line list 702 is a list of identification information on a payout line set to be a betting target. In the present embodiment, three rows of upper, middle, and lower rows of the symbol stop positions 7 are prepared as the payout lines, and thus serve as betting target candidates. Before the spinning starts, the list is reset to a predetermined value indicating that only the “middle row” is set as the betting target. Then, each time predetermined betting target adding operation input on the touch panel 1306 is detected, the identification information on the payout line is added one by one, in the order of the “upper row” and the “lower row”.

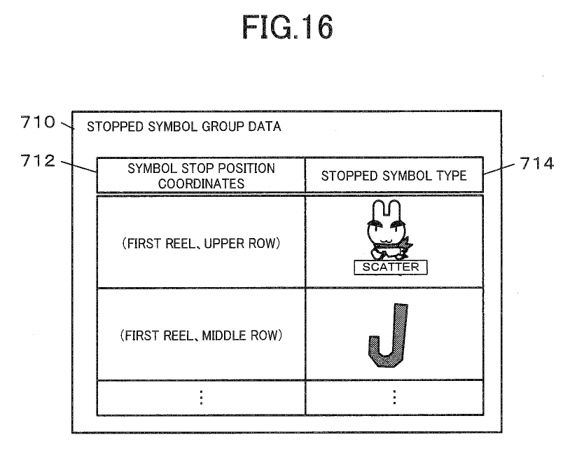

The stopped symbol group data 710 is a list of symbols that are each displayed at a corresponding one of the symbol stop positions in the reel display area 20 when the reels stop. As illustrated in FIG. 16, symbol stop position coordinates 712 and a stopped symbol type 714 stopped at the stop position are stored with one set of coordinates associated with one type.

Referring back to FIG. 13, before the spinning starts, the stopping order determination reference winning combination name 720 is reset to a predetermined value indicating “no name”. Then, any one of the winning combination names 531 (see FIG. 11) of the winning combinations determined to have been established after the stopped symbol group has been determined is set as the name. In the present embodiment, the name of one of the winning combinations with the highest payout rate is set.

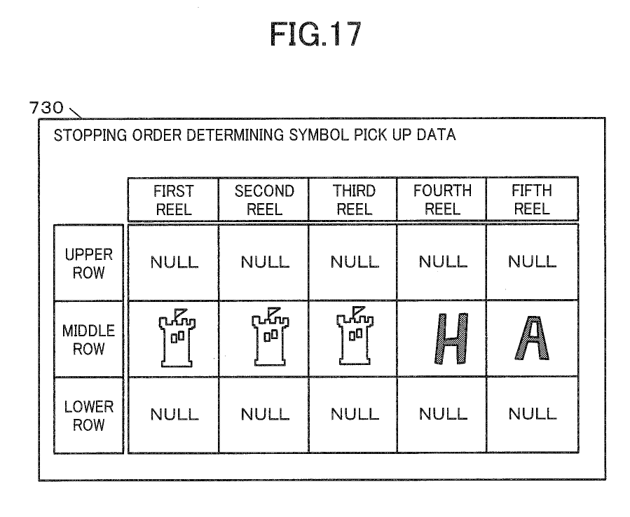

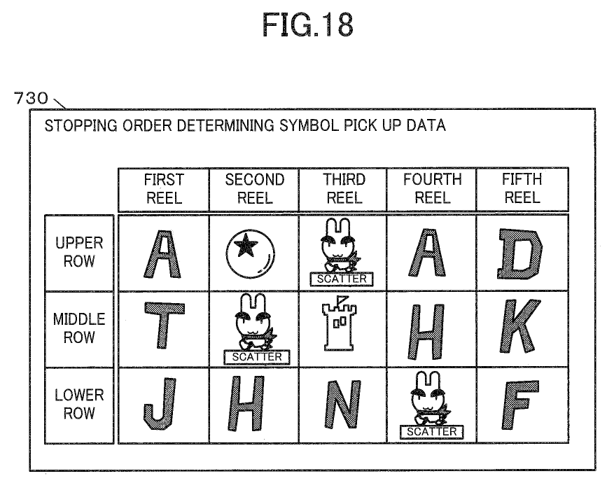

The stopping order determining symbol pick up data 730 is a list of symbols picked up from the determined stopped symbol group, for setting the reel stopping order. Specifically, as illustrated in FIG. 17 and FIG. 18, setting frames in a matrix form of all the symbol stop positions are prepared. An initial value of each setting frame is a predetermined value (NULL) indicating “not set”. Information on a symbol selected (=picked up) from the stopped symbol group data 710 (see FIG. 13) is set for a corresponding setting frame, based on the condition type 533 (see FIG. 14 and FIG. 15) of the winning combination defining data 530 matching the stopping order determination reference winning combination name 720. An example illustrated in FIG. 17 corresponds to an example illustrated in FIG. 14, and an example illustrated in FIG. 18 corresponds to an example illustrated in FIG. 15 and FIG. 5.

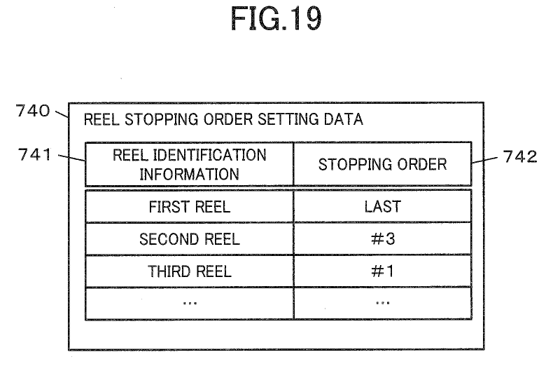

Referring back to FIG. 13, the reel stopping order setting data 740 defines the stopping order of each reel. Specifically, a stopping order 742 is stored for each reel identification information 741 as illustrated in FIG. 19. Before the spinning starts, the stopping order 742 is reset to a predetermined value indicating “not determined”.

Referring back to FIG. 13, the reel display control data 750 is a data set describing statuses of the reels displayed in the reel display area 20, and is a list in which the position and the type of the symbol displayed in the reel display area 20 are associated with each other. The control data sequentially changes while the reels are spinning, and provides a result matching the stopped symbol group data 710 when the reels stop spinning.

The bonus game control data 760 includes various types of control data for playing the bonus game stage.

[Process]

Next, operations of the video slot machine 1300 according to the present embodiment are described.

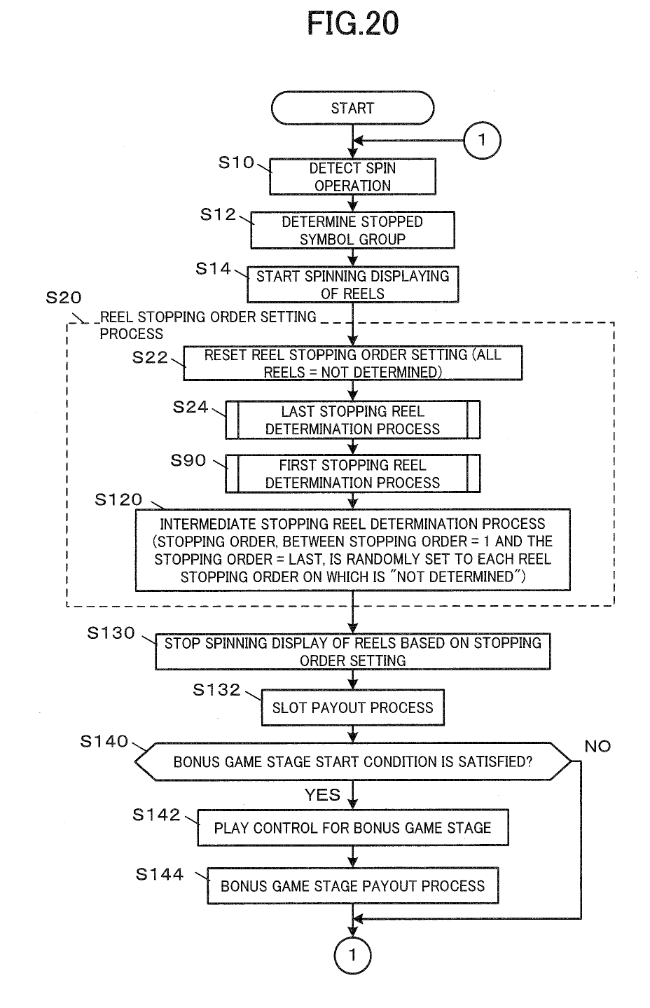

FIG. 20 is a flowchart illustrating a flow of a main process performed by the video slot machine 1300. The process steps for paying playing fee/betting fee, setting the betting rate, adding the payout line to be the betting target, and the like are omitted.

The video slot machine 1300 performs a lottery process to determine the stopped symbol group (step S12) when an operation on the spin button 1304, that is, a spin operation is detected (step S10).

How the stopped symbol group is determined can be selected as appropriate. For example, five random numbers corresponding to the first reel 21 to the fifth reel 25 are generated. Then, ranges each set for extracting three continuous symbols from the symbol column are determined based on the random numbers, in such a manner that the ranges do not overlap with each other. The ranges for extracting the symbols correspond to the ranges to be displayed on the reel display area 20 when the reels are stopped. The result of this setting is stored in the stopped symbol group data 710 (see FIG. 16).

Next, the video slot machine 1300 starts spinning displaying of the reels (circulating scroll displaying of the symbol columns) (step S14). As a result, the displaying involves sequential change in the reel display control data 750 (see FIG. 13).

Then, the video slot machine 1300 performs a reel stopping order setting process (step S20). In the reel stopping order setting process, first of all, the reel stopping order setting data 740 (see FIG. 19) is reset (step S22). Then, the last stopping reel determination process is performed (step S24).

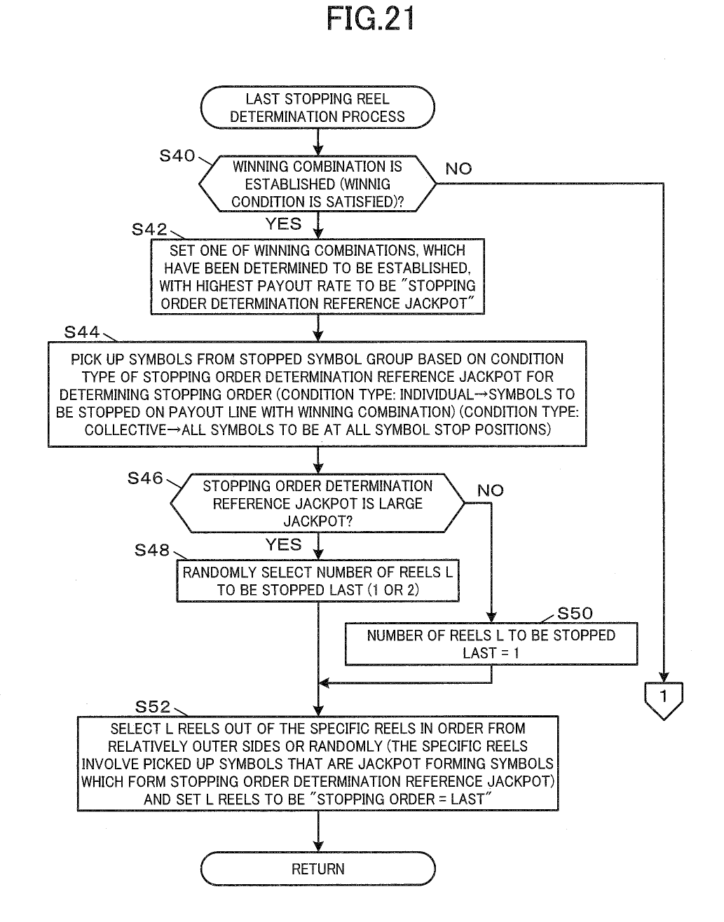

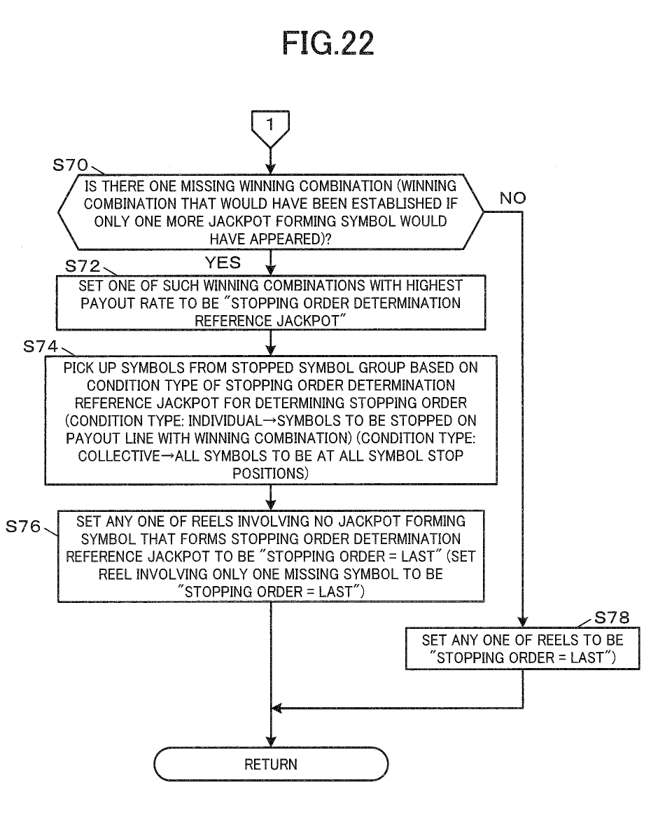

FIG. 21 to FIG. 22 are flowcharts illustrating a flow of the last stopping reel determination process. In this process, first of all, the video slot machine 1300 refers to the winning combination defining data 530 (see FIG. 14 and FIG. 15) and the stopped symbol group data 710 (see FIG. 16) to determine whether or not the winning combination is established with the content of the current stopped symbol group (step S40).

When any one of the winning combinations is established (YES in step S40), the video slot machine 1300 sets one of the winning combinations, which have been determined to be established, with the highest payout rate to be the “stopping order determination reference jackpot”, and stores the winning combination name 531 (see FIG. 15) of this jackpot in the stopping order determination reference winning combination name 720 (see FIG. 13) of the play data 700.

Then, the video slot machine 1300 selects (picks up) the symbols from the stopped symbol group data 710 based on the condition type 533 in the winning combination defining data 530 corresponding to the stopping order determination reference jackpot and stores the type information on the selected symbols in the stopping order determining symbol pick up data 730 (see FIG. 17 and FIG. 18) (step S44).

In this process, when the stopping order determination reference jackpot is a large jackpot (YES in step S46), the video slot machine 1300 randomly determines the number of reels L to be stopped last to be “1” or “2” (step S48). When the reference jackpot is not a large jackpot (NO in step S46), the number of reels L is set to be “1” (step S50).

Then, the video slot machine 1300 sets the number of reels L to be “stopping order=last” (step S52). Specifically, the symbols that have been picked up in step S44 are searched for a symbol corresponding to the jackpot forming symbol of the stopping order determination reference jackpot. Then, L reels are randomly selected or selected from the outer side, from reels involving the symbol found by the search, and the L reels are set to be “stopping order=last”. Then, the last stopping reel setting process is terminated.

When no winning combination is established with the stopped symbol group in the first place (NO in step S40), the process proceeds to FIG. 22, and the video slot machine 1300 determines whether or not the stopped symbol group is one short from establishing a winning combination (step S70). In other words, it is determined whether or not there is a winning combination that would have been established if only one more jackpot forming symbol would have appeared.

When there is such a winning combination (YES in step S70), the video slot machine 1300 sets one of the winning combinations with the highest payout rate to be the stopping order determination reference jackpot (step S72). Then, the symbols are selected (picked up) from the stopped symbol group data 710 based on the condition type 533 corresponding to the stopping order determination reference jackpot (step S74).

Then, the video slot machine 1300 sets any one of the reels with the symbol columns including the jackpot forming symbol, missing from the winning combination that would have been established, to be “stopping order=last” (step S76). Then, the last stopping reel setting process is terminated.

When there is no winning combination that is not established due to one symbol missing (NO in step S70), any one of the reels is set to be “stopping order=last” (step S78), and the last stopping reel setting process is terminated.

Referring back to the flowchart in FIG. 20, after the last stopping reel setting process is terminated, the video slot machine 1300 performs the first stopping reel determination process (step S90).

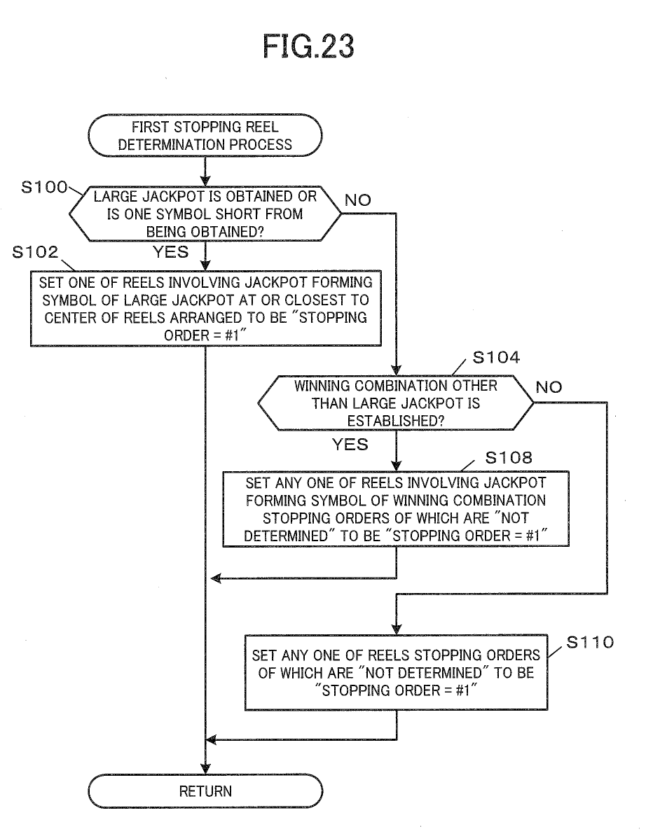

FIG. 23 is a flowchart illustrating a flow of the first stopping reel determination process. In this process, when a large jackpot is obtained with the content of the current stopped symbol group or when the content of the current stopped symbol group is one symbol short from obtaining a large jackpot (YES in step S100), the video slot machine 1300 sets one of the reels involving the jackpot forming symbol of the large jackpot at or closest to the center of the five reels arranged to be “stopping order=#1” (step S102). Then, the first stopping reel determination process is terminated.

When a winning combination other than the large jackpot is established (YES in step S104), any one of the reels involving the jackpot forming symbol of the winning combination the stopping orders of which are “not determined” is set to be “stopping order=#1” (step S108). Then, the first stopping reel determination process is terminated.

When no winning combination is established or no winning combination failed to be established due to one symbol missing (NO in step S104), any one of the reel involving the jackpot forming symbol of the winning combination the stopping orders of which are “not determined” is set to be “stopping order=#1” (step S110). Then, the first stopping reel determination process is terminated.

Referring back to the flowchart in FIG. 20, after the first stopping reel setting process has been terminated, the video slot machine 1300 performs the intermediate stopping reel determination process (step S120). Specifically, the stopping order, between the stopping order=#1 and the stopping order=last (#5 in the present embodiment), is randomly assigned to each of the reels the stopping order on which is still “not determined”.

When the stopping order of all of the reels has been determined, the video slot machine 1300 controls the reels that are displayed while spinning to be stopped based on the stopping order thus set, so that the stopped symbol group is displayed (step S130). Then, a payout process is performed (step S132).

Next, the video slot machine 1300 determines whether or not a bonus game stage start condition is satisfied (step S140). In the present embodiment, the start condition is determined to be satisfied when the stopped symbol group includes three scatter symbols 10s. Note that the start condition can be appropriately set.

When the start condition is satisfied (YES in step S140), the video slot machine 1300 performs play control for the bonus game stage (step S142), and performs bonus payout based on a result of playing the bonus game stage (step S144). Then, the process returns to step S10 to be prepared for the next spin to start.

In the present embodiment described above, the stopping orders of the reels can be changed in accordance with a group of stopped symbols to be stopped in the reel display area 20. Thus, for example, the timing at which the content of the stopped symbol group is determined to be realized by the player can be delayed so that the excitement can be maintained as long as possible.

In conventional cases where the stopping orders of the reels is fixed, the player realizes that his or her expectation was disappointed shortly after the reels start stopping depending on the content of the stopped symbol group. In such a case, the player might have nothing to do but wait until the remaining reels stop. In the present embodiment, the stopping orders of the reels are changed so that the reel involving the stopped symbol required for satisfying the winning condition stops last. Thus, an attractive slot machine enabling the player to feel excitement and thrill for a longer period of time can be achieved.

### Second Embodiment

Next, a second embodiment of the present invention is described. In the present embodiment, the video slot game is implemented as an online game. Components that are the same as the counterparts in the first embodiment are denoted with the same reference numerals, and the description thereof will be omitted. The difference from the first embodiment will be mainly described.

First of all, an example of a hardware configuration according to the present embodiment is described.

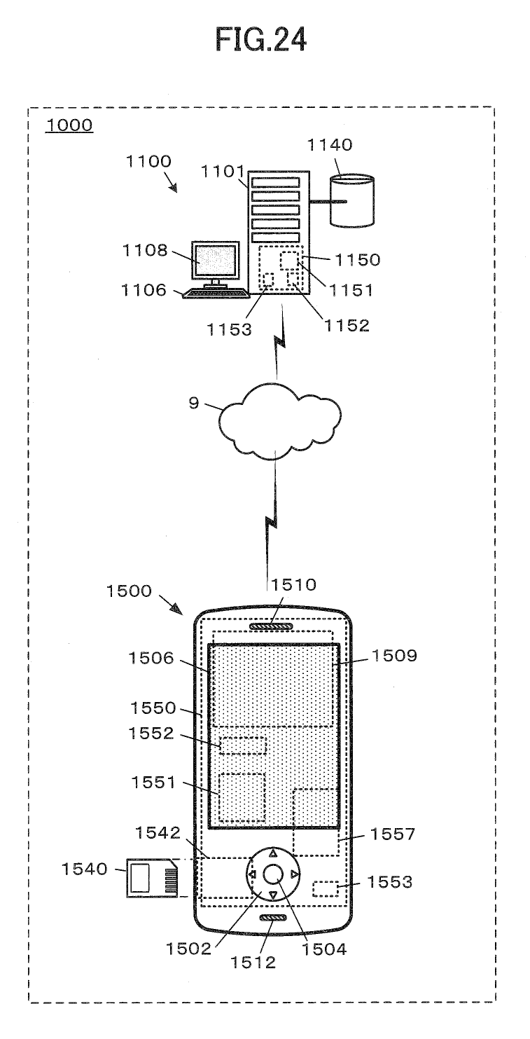

FIG. 24 is a diagram illustrating an example of a configuration of a game system according to the present embodiment. A game system 1000 according to the present embodiment is a computer system including a server system 1100 and a user terminal 1500 that can be connected to a communication line 9 to communicate with each other to exchange data. The example illustrated in FIG. 24 includes a single user terminal 1500. However, in an actual operation, a plurality of user terminals 1500 of different users who play the game (hereinafter, referred to as “players”) may each be connected to and communicate with the server system 1100. The game system 1000 as a whole may be referred to as a computer system, or the server system 1100 and the user terminal 1500 may each be referred to as an individual computer system.

The communication line 9 is a communication channel that enables data communications. Specifically, the communication line 9 includes a communication network such as a local area network (LAN) using a private line (private cable) for direct connection, Ethernet (registered trademark), and the like, a telecommunication network, a cable network, and the Internet. The communication method may be a cable communication method or a wireless communication method.

The server system 1100 includes a main body device 1101, a keyboard 1106, a touch panel 1108, and a storage 1140. A control board 1150 is provided in the main body device 1101.

The control board 1150 includes microprocessors of various types (e.g., a CPU 1151, a GPU, and a DSP), an IC memory 1152 of various types (e.g., a VRAM, a RAM, and a ROM), and a communication device 1153. The control board 1150 may partially or entirely be implemented with an ASIC, a FPGA, and an SoC.

Through a calculation process performed by the control board 1150 based on a predetermined program and data, the server system 1100 implements 1) a user management function of managing a process related to user registration and the like and user-related information, 2) an online shopping function of selling tokens in the video slot game to the user online, and 3) a game management function of providing data required to play the slot play with the user terminal 1500, to manage play control on the game played with the user terminal 1500. Thus, the video slot game according to the present embodiment is implemented as one type of client-server games.

The server system 1100 is illustrated/described as a single server. Alternatively, a plurality of blade servers, in charge of various functions, may be installed while being connected to each other via an internal bus to be capable of performing data communications with each other. Furthermore, a plurality of independent servers, disposed in locations distant from each other, may perform data communications with each other via the communication line 9 to function as the server system 1100 as a whole.

The server system 1100 is not limited to a configuration managed by a single administrator, and may be a system in which servers managed by different administrators are connected to each other in such a manner as to be able to communicate with each other. For example, the video slot game and the online shopping may be managed by different administrators and implemented by difference servers connected to each other in such a manner as to be able to communicate with each other to function as an integrated server system.

The user terminal 1500 is a computer system, usable by a registered user serving as a player to play the slot play, and is an electronic device (electronic apparatus) that can access the server system 1100 via the communication line 9 to implement the game. The user terminal 1500 according to the present embodiment is a device known as a smartphone. The user terminal 1500 may also be a personal computer, a tablet computer, a wearable computer, or the like.

The user terminal 1500 includes an arrow key 1502, a button switch 1504, the touch panel 1506 that functions as an image display device and a touch position input device, a built-in battery 1509, a speaker 1510, a microphone 1512, a control board 1550, and a memory card reader 1542 that can write and read data to and from a memory card 1540 that is a computer readable storage medium. The user terminal 1500 further includes a power button, a volume control button, and the like (not illustrated). Furthermore, the user terminal 1500 may be provided with an IC card reader that can implement contactless writing and reading of data to and from an IC card as a credit card or a prepaid card usable for payment involved in playing the slot.

The control board 1550 includes a microprocessor of various types (e.g., the CPU 1551, a GPU, and a DSP), an IC memory 1552 of various types (e.g., a VRAM, a RAM, and a ROM), a wireless communication module 1553 for performing wireless communications with a mobile phone base station, a wireless LAN base station, or the like connected to the communication line 9, an interface circuit 1557, and the like.

The interface circuit 1557 includes circuits such as a driver circuit that drives the touch panel 1506, a circuit that receives signals from the arrow key 1502 and the button switch 1504, an output amplifier circuit that outputs a sound signal to the speaker 1510, an input signal generation circuit that generates a signal corresponding to the sound collected by the microphone 1512, and a signal input-output circuit that inputs and outputs a signal to and from the memory card reader 1542.

The elements mounted on the control board 1550 are electrically connected with each other via a bus circuit or the like to be capable of exchanging data and signals. The control board 1550 may partially or entirely be implemented with an ASIC, an FPGA, or a SoC. The control board 1550 stores a client program and various types of data, for implementing a function as a user terminal of the video slot game according to the present embodiment, in the IC memory 1552.

The client program and various types of setting data are downloaded by the user terminal 1500 from the server system 1100 in the present embodiment. The program and the data may also be read from a storage medium such as the memory card 1540 additionally provided.

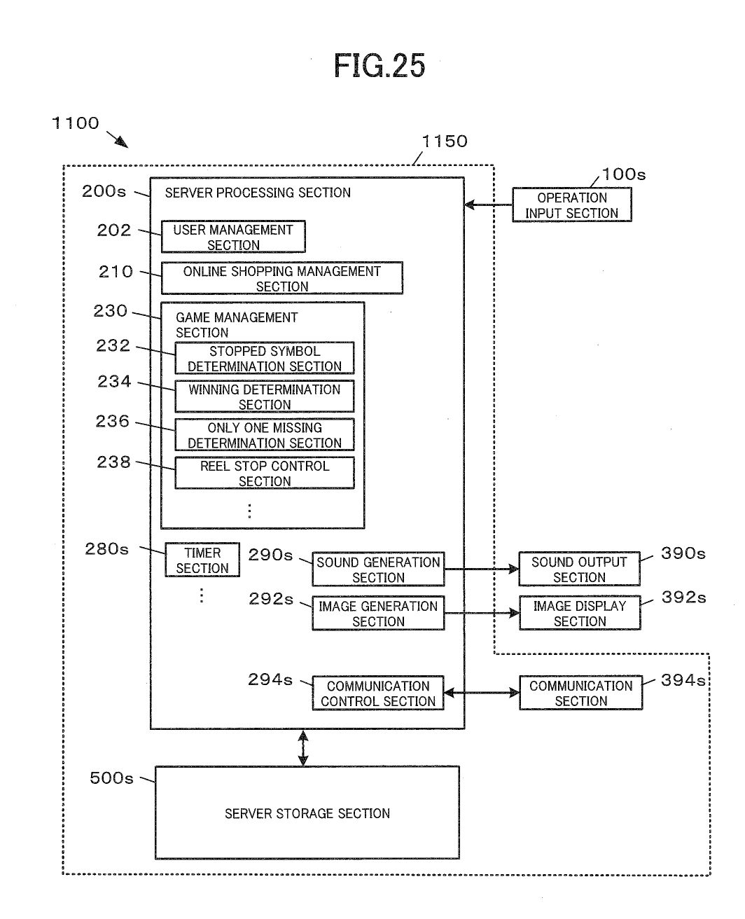

FIG. 25 is a block diagram illustrating an example of the configuration of the server system 1100 according to the present embodiment. The server system 1100 according to the present embodiment includes an operation input section 100s, a server processing section 200s, a sound output section 390s, an image display section 392s, a communication section 394s, and a server storage section 500s.

The operation input section 100s is for inputting various operations for management. The keyboard 1106 in FIG. 24 corresponds to this section.

The server processing section 200s is implemented with electronic parts such as a microprocessor (e.g., a CPU and a GPU), an ASIC, and an IC memory. The server processing section 200s controls data exchanged between functional sections including the operation input section 100s and the server storage section 500s, and performs a calculation process based on a predetermined program, data, the operation input signal from the operation input section 100s, data revived from the user terminal 1500, and the like to entirely control the operation of the server system 1100.

The server processing section 200s according to the present embodiment includes a user management section 202, an online shopping management section 210, a game management section 230, a timer section 280s, a sound generation section 290s, an image generation section 292s, and a communication control section 294s. Note that other functional sections other than these may be included as appropriate.

The user management section 202 performs a process related to a user registration procedure and manages the data of each user associated with the account (user ID). In the present embodiment, the section has various functions including: 1) issuing an account to a registered user; 2) registration information management for registering and managing personal information for each account; 3) book keeping management for a payment medium consumed for paying for a charged element related to the video slot game (in the present embodiment, purchase of a token, playing fee for the slot game); and 4) play history management for managing login/logout history. Note that any other appropriate management function for other data associated with the account can be included.

The online shopping management section 210 is in charge of control related to the online shopping that is one of the charged elements, and can be implemented with a known online shopping technique. In the present embodiment, the player can purchase tokens of a video slot through online shopping. Any other elements may be set as appropriate to be sold in the online shopping.

The timer section 280s uses a system clock to obtain the current date and time, a time limit, and the like.

The sound generation section 290s is implemented with an integrated circuit (IC) or by executing software that generates sound data and performs decoding, and generates or decodes sound data on a sound related to system management for the server system 1100 or related to the slot play, background music (BGM), and a character voice. The resultant sound signal related to the system management is output to the sound output section 390s.

The sound output section 390s receives the sound signal to emit the corresponding sound, and corresponds to a speaker (not illustrated) of the main body device 1101 or the touch panel 1108 in the example illustrated in FIG. 24.

The image generation section 292s can generate an image related to the system management for the server system 1100, a game image (or data for displaying the game image on the user terminal 1500), and the like. The image related to the system management can be output to the image display section 392s.

The image display section 392s displays various images for system management based on the image signals input from the image generation section 292s. The image display section 392s may be implemented with an image display device such as a flat panel display, a cathode ray tube (CRT), a projector, or a head-mounted display. The image display section 392s corresponds to the touch panel 1108 in the example illustrated in FIG. 24.

The communication control section 294s performs a data process related to the data communication, and exchanges data with an external device through the communication section 394s. In the present embodiment, a process related to the data communications with the user terminal 1500 is performed.

The communication section 394s connects to the communication line 9 to implement communications. The communication section 394s is implemented with a transceiver, a modem, a terminal adapter (TA), a jack for a communication cable, a control circuit, and the like. In the example illustrated in FIG. 24, the communication device 1153 corresponds to the communication section 394s.

The server storage section 500s stores a program and various types of data for implementing various functions of the server processing section 200s for entirely controlling the server system 1100. The server storage section 500s is used as a work area for the server processing section 200s, and temporarily stores the results of calculations performed by the server processing section 200s based on various programs. The function of the information storage section 500s is implemented with an IC memory (e.g., RAM and ROM), a magnetic disk (e.g., hard disk), an optical disk (e.g., CD-ROM and DVD), an online storage, or the like corresponding to a storage medium such as the IC memory 1152 and hard disk mounted in the main body device 1101 and the storage 1140, in the example illustrated in FIG. 24.

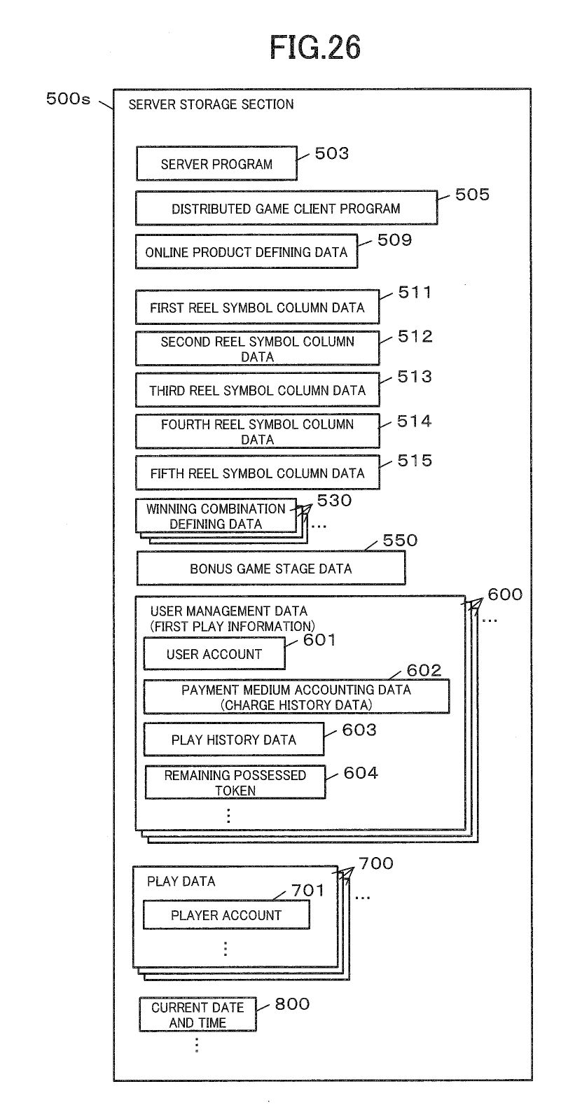

FIG. 26 is a diagram illustrating an example of a program and data stored in the server storage section 500s according to the present embodiment. The server storage section 500s stores therein in advance, a server program 503, a distribution game client program 505, online product defining data 509, first reel symbol column data 511, second reel symbol column data 512, third reel symbol column data 513, fourth reel symbol column data 514, fifth reel symbol column data 515, winning combination defining data 530, and bonus game stage data 550.

The server storage section 500s stores data, sequentially generated and managed, including user management data 600, play data 700, and current date and time 800. Furthermore, the server storage section 500s may store information on a timer, a counter, various flags, and the like as appropriate.

The server program 503 is read out and executed by the sever processing section 200s for implementing functions of the user management section 202, the online shopping management section 210, and the game management section 230 (see FIG. 25).

The distributed game client program 505 is an original of a game client program provided to the user terminal 1500.

The online product defining data 509 is data defining a product purchasable through the online shopping implemented by the online shopping management section 210 (see FIG. 25).

The user management data 600 is prepared for each registered user, that is, for each player, and includes various types of data associated with the user account. In other words, the data is first play information on a player related to the video slot game. For example, one user management data 600 includes a unique user account 601, payment medium accounting data 602, play history data 603, and remaining possessed token 604. Note that other data can be included as appropriate.

The payment medium accounting data 602 serves as what is known as an account book storing therein information on a charged/consumed amount of the payment medium associated with the user, information on a reason for the charging/consumption, and information on changed date and time in association with each other. This data can also be referred to as charge history data or charge information.

The play history data 603 is data in which the past game played timings are stored in series, and is automatically updated at a login/logout timing.

The play data 700 according to the present embodiment basically includes the same configuration as that in the first embodiment (see FIG. 10), and additionally includes a player account 701 that indicates the player to which the play data is related.

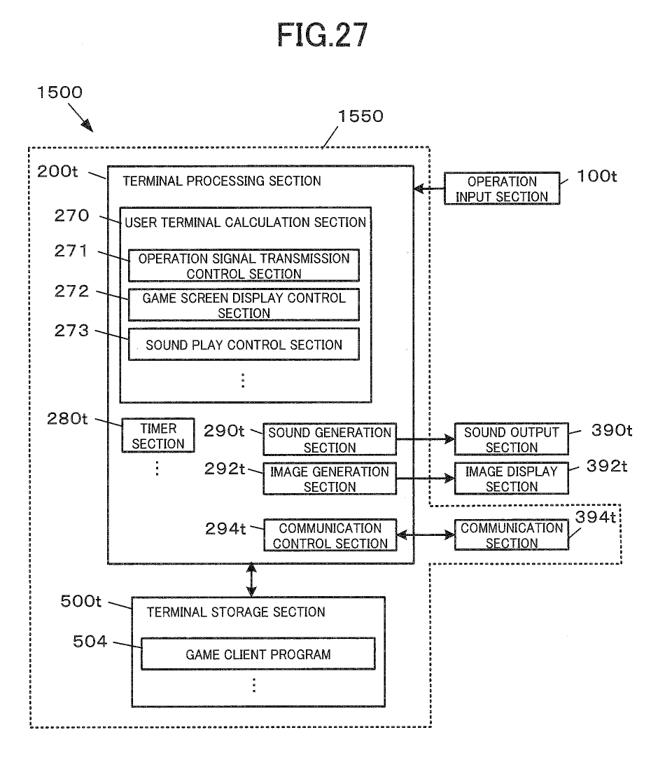

FIG. 27 is a block diagram illustrating an example of a configuration of the user terminal 1500 according to the present embodiment. The user terminal 1500 according to the present embodiment includes an operation input section 100t, a terminal processing section 200t, a sound output section 390t, an image display section 392t, a communication section 394t, and a terminal storage section 500t.

The operation input section 100t outputs an operation input signal, based on various operations input by the player, to the terminal processing section 200t, and can be implemented with a push switch, a joystick, a touch pad, a track ball, an accelerometer, a gyro, a CCD module, or the like. The operation input section 100t corresponds to the arrow key 1502, the button switch 1504, and the touch panel 1506 in FIG. 24.

The terminal processing section 200t is implemented with electronic parts such as a microprocessor (e.g., CPU and GPU), an ASIC, and an IC memory. The terminal processing section 200t performs input/output control to exchange data with each of the functional sections including the operation input section 100t and the terminal storage section 500t. The terminal processing section 200t executes various calculation processes based on a predetermined program or data, the operation input signal from the operation input section 100t, and various types of data received from the sever system 1100 to control the operation of the user terminal 1500. The terminal processing section 200t corresponds to the control board 1550 in FIG. 24. The terminal processing section 200t according to the present embodiment includes a user terminal calculation section 270, a timer section 280t, a sound generation section 290t, an image generation section 292t, and a communication control section 294t.

The user terminal calculation section 270 includes an operation signal transmission control section 271, a game screen display control section 272, and a sound play control section 273.

The operation signal transmission control section 271 performs a process of transmitting various types of data and a request to the sever system 1100 in accordance with an operation on the operation input section 100t.

The game screen display control section 272 performs control for displaying a game screen of the video slot game based on various types of data received from the server system 1100. In this configuration, the server system 1100 generates the image of the game screen. Alternatively, a configuration where the user terminal 1500 generates the image may also be employed.

The sound play control section 273 performs control to emit a sound (for example, sound effects, a BGM, and the like) based on various types of sound data received from the server system 1100.

For example, the sound generation section 290t is implemented with a processor such as a DSP or a sound synthesizing IC, an audio codec for playing a sound file, or the like, and generates a sound signal for sound effects, a BGM, various types of operation sounds, and the like related to the video slot game, and outputs the signal thus generated to the sound output section 390t.

The sound output section 390t is implemented with a device that outputs sound such as sound effects, a BGM, or the like, based on the sound signal received from the sound generation section 290t. The sound output section 390t corresponds to the speaker 1510 in FIG. 24.

For example, the image generation section 292t is implemented with a processor (e.g., a GPU or a DSP), a video signal IC, a program (e.g., video codec), a drawing frame IC memory (e.g., frame buffer), and the like.

The image generation section 292t generates an image of one game screen every frame (e.g., 1/60th of a second) based on the various types of data received from the server system 1100, and outputs the generated image signal of the game screen to the image display section 392t.

The image display section 392t displays various game images based on the image signals input from the image generation section 292t. The image display section 392t may be implemented with an image display device such as a flat panel display, a cathode ray tube (CRT), a projector, or a head-mounted display. In the present embodiment, the touch panel 1506 illustrated in FIG. 24 corresponds to the image display section 392t.

The communication control section 294t performs a data process related to the data communication, and exchanges data with an external device through the communication section 394t. The communication section 394t connects to the communication line 9 to implement communications. For example, the communication section 394t is implemented by a transceiver, a modem, a TA, a jack for a communication cable, a control circuit, and the like, and corresponds to the wireless communication module 1553 in FIG. 24.

The terminal storage section 500t stores therein a system program for implementing various functions for causing the terminal processing section 200t to entirely control the user terminal 1500, a program and various types of data required for the video slot game, and the like. The terminal storage section 500t is used as a work area for the terminal processing section 200t, and temporarily stores a result of calculation performed by the terminal processing section 200t in accordance with various programs, input data received from the operation input section 100t, and the like. These functions are implemented by an IC memory (e.g., RAM and ROM), a magnetic disk (e.g., hard disk), an optical disk (e.g., CD-ROM and DVD), or the like, and correspond to the IC memory 1552 and the memory card 1540 in the control board 1550 illustrated in FIG. 24. The terminal storage section 500t may be implemented with an online storage.

The terminal storage section 500t according to the present embodiment stores therein a game client program 504. Note that other data can be included as appropriate. The game client program 504 is application software that implements a function of the user terminal calculation section 270 when read and executed by the terminal processing section 200t, and may be embedded as a part of the terminal system program. In the present embodiment, the game client program 504 is a copy of the distributed game client program 505 (see FIG. 26) provided from the server system 1100.

The game client program 504 may be implemented with a dedicated client program or with a web browser program and a plugin that implements an interactive image display, depending on a technique and a method for implementing the video slot game.

The operation of the game system 1000 may be regarded as being executed by the server system 1100 through the flowcharts in FIGS. 20 to 23.

The present embodiment can provide the same advantageous effect as the first embodiment through the online game.

### Third Embodiment

Next, a third embodiment of the present invention is described.

The present embodiment is implemented to be basically the same as the second embodiment, but is different from the second embodiment in that the user terminal 1500 controls the progress of the video slot game. The following mainly describes differences from the second embodiments. Components that are the same as the counterparts in the first and second embodiments are denoted with the same reference numerals, and the description thereof will be omitted.

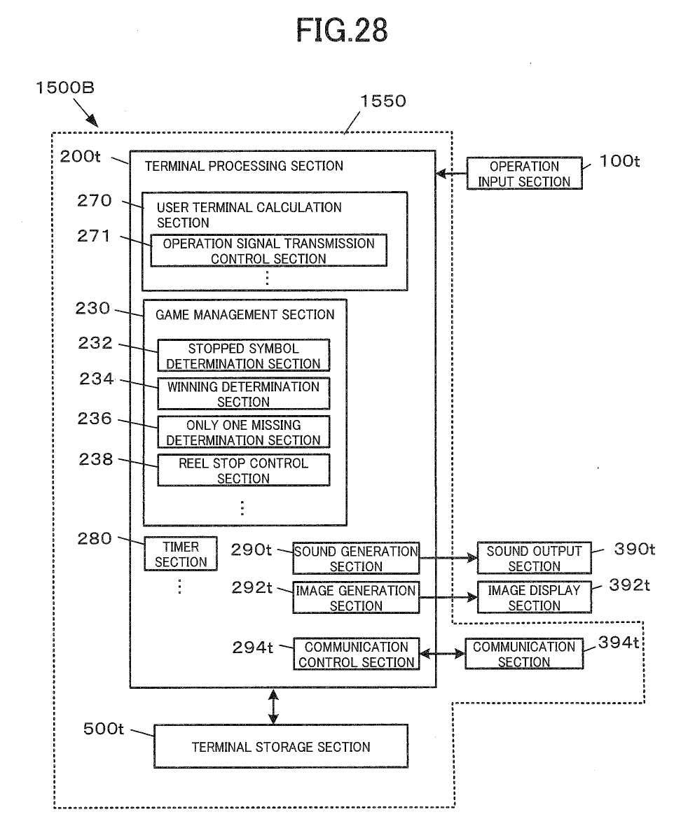

FIG. 28 is a block diagram illustrating an example of a configuration of a user terminal 1500B according to the present embodiment. The user terminal 1500B according to the present embodiment is a terminal in which the game screen display control section 272 and the sound play control section 273 are omitted and the game management section 230 is provided instead. Specifically, the user terminal 1500B according to the present embodiment independently performs a calculation process related to the game progress and generates images of the game space.

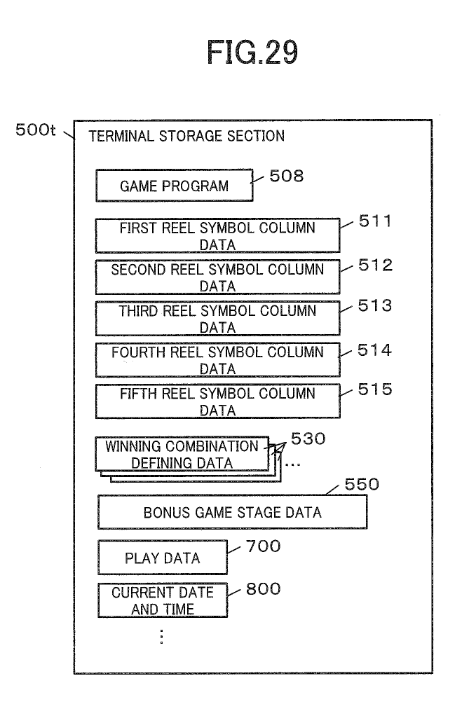

FIG. 29 is a diagram illustrating an example of a program and data stored in the terminal storage section 500 of the user terminal 1500B according to the present embodiment. The terminal storage section 500 according to the present embodiment stores therein a game program 508. The game program 508 is a program that causes the terminal processing section 200 to implement the user terminal calculation section 270 and the game management section 230 according to the present embodiment. In the present embodiment, as the game management section 230 is implemented with the user terminal 1500B, data from the first reel symbol column data 511 to the current date and time 800 not including the user management data 600 is stored in the terminal storage section 500t.

A flow of the process according to the present embodiment is basically the same as the flow of the process performed by the sever system 1100 according to the second embodiment, that is, the flowcharts in FIG. 20 to FIG. 23 according to the first embodiment. The user terminal 1500B implements the game management section 230, and thus the subject of each step may be changed to the server system 1100 or the user terminal 1500B as appropriate. When the user terminal 1500B performs a process requiring the user management data 600 to be referred to, such as login, the server system 1100 is requested to provide required data or perform matching, or may be requested to perform the entire process.

The present embodiment can provide the same advantageous effect as the first and second embodiments.

The user terminal 1500B may be partially in charge of the functions of the game management section 230 in a limited manner, instead of being entirely in charge of the functions.

[Modification]

The embodiments to which the present invention is applied have been described above. Note that the present invention is not limited thereto. Various modifications may be made as appropriate, such as adding other elements, omitting some of the elements, or changing some of the elements.

[First Modification]

For example, the theme and the game world of the video slot game can be set differently as appropriate, and the design of the game screen can be changed accordingly.

Although only some embodiments of the present invention have been described in detail above, those skilled in the art will readily appreciate that many modifications are possible in the embodiments without materially departing from the novel teachings and advantages of this invention. Accordingly, all such modifications are intended to be included within scope of this invention.

What is claimed is:

1. A video slot machine comprising: at least one processor or circuit programmed to execute as:
determining stopped symbols, in symbol column of reels scroll displayed, to be stopped in a reel display area, by performing a predetermined lottery process in response to a predetermined start operation; and
controlling stopping orders of the reels based on the stopped symbols.

2. The video slot machine as defined in claim 1 further comprising determining whether or not a predetermined winning condition is satisfied based on the stopped symbols,
the controlling the stopping orders of the reels including making, when the winning condition is satisfied, a reel involving a stopped symbol required for satisfying the winning condition to be stopped last.

3. The video slot machine as defined in claim 2 further comprising determining whether or not an only one missing condition is satisfied with the winning condition failed to be satisfied due to only one missing symbol based on the stopped symbol, the only missing symbol being a missing symbol in a case where the winning condition is not satisfied due to only one symbol missing,
the controlling the stopping orders of the reels including making, when the only one missing condition is satisfied, a reel involving the only missing symbol to be stopped last.

4. The video slot machine as defined in claim 2, a special symbol is included in the symbol columns of M (N>M≥2) reels of the reels including N (N≥3) reels,
the winning condition including a condition satisfied when the stopped symbols in the M reels include the special symbol.

5. The video slot machine as defined in claim 2, the controlling the stopping orders of the reels including making, when the stopped symbols include at least one symbol required for satisfying the winning condition, a reel involving the symbol to be stopped first.

6. The video slot machine as defined in claim 3, the controlling the stopping orders of the reels including making, when the stopped symbols include at least one symbol required for satisfying the winning condition, a reel involving the symbol to be stopped first.

7. The video slot machine as defined in claim 4, the N being N≥4,
the controlling the stopping orders of the reels including determining, when the winning condition is satisfied, reels involving stopped symbols required for satisfying the winning condition to be a first stopped reel and a last stopped reel, and randomly determining reels to be stopped after the first stopped reel and before the last stopped reel.

8. The video slot machine as defined in claim 2, the winning condition including a plurality of types of winning conditions with different payouts,
the controlling the stopping orders of the reels including making, when a plurality of the winning conditions are satisfied, a reel involving a stopped symbol required for satisfying one of the winning conditions with largest payout, to be stopped last.

9. The video slot machine as defined in claim 3, the winning condition including a plurality of types of winning conditions with different payouts,
the controlling the stopping orders of the reels including making, when a plurality of the winning conditions are satisfied, a reel involving a stopped symbol required for satisfying one of the winning conditions with largest payout, to be stopped last.

10. The video slot machine as defined in claim 1, the controlling the stopping orders of the reels including controlling number of reels to be stopped last at one time.

11. The video slot machine as defined in claim 8, the controlling the stopping orders of the reels including controlling number of reels to be stopped last at one time.

12. The video slot machine as defined in claim 9, the controlling the stopping orders of the reels including controlling number of reels to be stopped last at one time.

13. A server system comprising: at least one processor or circuit programmed to execute as:
causing a user terminal to control progress of a video slot game in which symbol columns of reels are scroll displayed in response to a predetermined start operation;
determining stopped symbols, in the symbol columns of the reels, to be stopped in a reel display area, by performing a predetermined lottery process in response to the start operation; and
controlling stopping orders of the reels based on the stopped symbols.

14. A computer system including a user terminal on which a user inputs an operation and a server system,
the server system comprising: at least one processor or circuit programmed to execute as:
causing a user terminal to control progress of a video slot game in which symbol columns of reels are scroll displayed in response to a predetermined start operation;
determining stopped symbols, in the symbol columns of the reels, to be stopped in a reel display area, by performing a predetermined lottery process in response to the start operation; and
controlling stopping orders of the reels based on the stopped symbols.
